(19) United States
(12) Patent Application Publication
(10) Pub. No.: US 2017/0295992 A1
(43) Pub. Date: Oct. 19, 2017

(54) VACUUM-OPERATED BEVERAGE BREWERS AND RELATED BREWING METHODS

(71) Applicant: Alpha Dominche Holdings, Inc., Dallas, TX (US)

(72) Inventors: Adam Roth Mangold, Brooklyn, NY (US); Tymer T. Tilton, Brooklyn, NY (US)

(21) Appl. No.: 15/488,296

(22) Filed: Apr. 14, 2017

Related U.S. Application Data
(60) Provisional application No. 62/322,648, filed on Apr. 14, 2016.
(60) Provisional application No. 62/377,442, filed on Aug. 19, 2016.

(51) Int. Cl. A47J 31/46; A47J 31/00; A47J 31/20; A47J 31/44

(52) U.S. Cl. CPC A47J 31/46; A47J 31/4403; A47J 31/002; A47J 31/20

(57) ABSTRACT

Brewing assemblies and related brewing methods. In some embodiments, the assembly may be configured to allow for improved, precision control over one or more aspects, stages, and/or parameters of the brewing process. For example, some embodiments may allow for full-immersion brewing for a precise, controlled period of time, which time may be controlled by application of a pressure differential to actuate a valve for and/or provide a force to assist in delivery of a brewed beverage from a brewing chamber of the assembly. Some embodiments may further provide for various pre-infusion steps/stages and/or post-immersion steps/stages.

### RELATED APPLICATIONS

This application claims the benefit under 35 U.S.C. §119(e) of U.S. Provisional Patent Application No. 62/322,648 filed Apr. 14, 2016 and titled “VACUUM-CONTROLLED BEVERAGE BREWERS AND RELATED BREWING METHODS” and U.S. Provisional Patent Application No. 62/377,442 filed Aug. 19, 2016 and titled “VACUUM-OPERATED BEVERAGE BREWERS AND RELATED BREWING METHODS,” both of which are incorporated herein by reference in their entireties.

### SUMMARY

Various embodiments of apparatus and methods are disclosed herein that relate to beverage brewers, such as coffee and/or tea brewers. Some embodiments disclosed herein may comprise a vacuum or other means for creating a pressure differential, which may be used to assist in movement of liquid from one chamber to another, such as from a brewing chamber to a delivery chamber, which delivery chamber may, in some such embodiments, comprise a carafe or other suitable container for pouring and/or consuming the beverage following brewing.

In some embodiments, the vacuum may also be used to actuate a valve for delivery of liquid from one chamber to another, such as from a brewing chamber to a delivery chamber following brewing of the beverage. In some such embodiments, the vacuum may also be used to assist in moving the liquid between chambers. However, alternatively, the vacuum may only be used to assist in moving the liquid between chambers, or may only be used to actuate a valve to facilitate such movement.

In some embodiments and implementations, the brew process may comprise a full immersion and/or the brewer may be configured to provide for a full immersion brewing of the beverage. In other words, the coffee or other brewing material is fully, or at least substantially fully, immersed in hot water or another liquid for most or all of the brewing process. However, unlike a typical French-press brewing approach, in preferred embodiments and implementations, the liquid may be delivered from one chamber to another, and ultimately to a carafe or other container, without requiring any manual steps, which may allow for providing a more consistent and repeatable brew and beverage.

In a more particular example of a brewing assembly according to certain preferred embodiments, the assembly may comprise a brewing chamber configured to brew a beverage therein, a delivery chamber configured to receive a brewed beverage from the brewing chamber, and a valve positioned between the brewing chamber and the delivery chamber. The delivery chamber may be fluidly sealed with respect to the brewing chamber and the valve may be configured to, upon actuation, allow for fluid communication between the brewing chamber and the delivery chamber. The assembly may further comprise a vacuum tube coupled with the delivery chamber and configured to apply a pressure differential to assist in delivering the brewed beverage from the brewing chamber to the delivery chamber.

In some embodiments, the valve may comprise a passive valve, such as a vacuum-actuated valve. Thus, in some such embodiments, the vacuum-actuated valve may be configured to automatically open to allow for delivery of the brewed beverage from the brewing chamber to the delivery chamber upon generation of a predetermined pressure differential between the delivery chamber and the brewing chamber. In some embodiments, the valve may comprise a three-way valve. More particularly, in some such embodiments, the three-way valve may comprise three configurations: a first open configuration in which the brewing chamber may be open or fluidly coupled with respect to the delivery chamber/carafe; a second open configuration in which the brewing chamber is may be open or fluidly coupled with respect to another element of the assembly, such as a drain and/or drain line; and a closed configuration in which the brewing chamber may be closed with respect both the delivery chamber and the drain, drain line, or other element.

In some embodiments, the delivery chamber may comprise a carafe. In some such embodiments, the carafe may be removable from the brewing assembly.

In another example of a brewing assembly according to other preferred embodiments, the assembly may comprise a brewing chamber configured to brew a beverage therein, a delivery chamber configured to receive a brewed beverage from the brewing chamber, a gas line for delivery of a temperature-controlled gas into at least one of the brewing chamber and the delivery chamber, a valve positioned between the brewing chamber and the delivery chamber, and a heating element functionally coupled with the gas line and configured to heat a gas prior to delivery of the gas into the brewing chamber.

In some embodiments, the brewing assembly may be configured to deliver the temperature-controlled gas into the at least one of the brewing chamber and the delivery chamber prior to the brewing chamber receiving a liquid therein for brewing the beverage. In some such embodiments, the brewing assembly may only be configured to deliver the temperature-controlled gas into the brewing chamber. The gas may, for example, be used to pre-heat one or more of the chambers and/or to agitate the grounds or other brewing material before and/or during brewing.

In some embodiments, the gas may be considered, for purposes herein to “lack steam.” In other words, although it should be recognized that a certain amount of moisture may be present in the gas, such as air, in embodiments and implementations considered to “lack steam,” there is not a deliberate effort to add additional water content such that the gas can reasonably be considered “steam.”

In some embodiments, however, steam may be used, either separately or in conjunction with the gas, to provide agitation, for example. Thus, some embodiments may comprise a steam feed line configured to deliver steam into the brewing chamber during brewing. In some such embodiments, the gas line may be fluidly coupled with the steam feed line such that, for example, the gas may combine with the steam to alter the temperature of the steam, alter the water content of the steam (i.e., make it “dryer”), and/or assist in delivering the steam (provide additional force for agitation, for example).

Some embodiments may further comprise a vacuum pump or other suitable means for generating a pressure differential between the brewing chamber and the delivery chamber. In some such embodiments, the valve may comprise a vacuum-actuated valve configured to open upon actuation of the vacuum pump to allow the brewed beverage to flow from the brewing chamber to the delivery chamber. In some embodiments, the pressure differential may not only open the valve, but may also be used to force (in some embodiments along with gravity) the brewed beverage out of the brewing chamber.

In an example of a method for brewing a beverage according to certain preferred implementations, the method may comprise the steps of delivering a liquid into a brewing chamber, initiating a brew process in the brewing chamber, applying a pressure differential between the brewing chamber and a delivery chamber, opening a valve between the brewing chamber and the delivery chamber, and delivering a brewed beverage from the brewing chamber into the delivery chamber.

As previously mentioned, in some implementations, the valve may comprise a passive valve. Thus, in some such implementations, the step of opening the valve may be performed automatically upon applying the pressure differential between the brewing chamber and the delivery chamber.

Alternatively, the valve may comprise an electronically-actuatable valve. In some such implementations, the step of opening the valve may comprise delivering a signal to the valve to open the valve. As previously mentioned, in some embodiments and implementations, the valve may comprise a three-way valve.

In some implementations, the step of applying a pressure differential between the brewing chamber and the delivery chamber may comprise actuating a vacuum pump fluidly coupled with the delivery chamber.

Some implementations may further comprise selecting a recipe comprising one or more brew parameters (a plurality of brew parameters in preferred embodiments and implementations), which may be input using a user interface. Examples of such brew parameters include, for example, a desired temperature for the liquid used for brewing, pre-wetting, agitation, steeping times, pre-wetting delay periods, etc., as described in greater detail below. In some embodiments and implementations, the parameters may allow a user to select a total brew time and adjust a variety of pre-infusion times as a percent of the total brew time. For example, upon selecting a total brew time, increasing a pre-infusion step time may result in decreasing the steeping time and/or other pre-infusion steps so as to maintain the total brew time. Similarly, a user may be allowed to select each of the various stages as a percent of the total brew time. Thus, for example, increasing a total brew time may automatically increase each of the various stage times in accordance with their respective percentages. After selecting the various parameters, the assembly may be configured to automatically initiate and perform a complete brew process according to each of the plurality of brew parameters.

In some implementations, the brew process may comprise full immersion brewing. However, as previously mentioned, some implementations may provide for one or more pre-infusion stages. Thus, in some such implementations, the brew process may further comprise at least one pre-infusion stage, which may comprise, for example, at least one of a pre-wetting stage of brewing material and an agitation stage of brewing material prior to the full immersion brewing.

The features, structures, steps, or characteristics disclosed herein in connection with one embodiment may be combined in any suitable manner in one or more alternative embodiments.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a perspective view of a brewing assembly according to one embodiment;

FIGS. 2-5 are cross-sectional views of the brewing assembly of FIG. 1 in various stages of a preferred brewing process;

FIG. 6 is a perspective view of a brewing assembly according to another embodiment;

FIG. 7 is a cross-sectional view of a portion of the brewing assembly of FIG. 6;

FIG. 8 is a flow chart of a brewing process according to some implementations;

FIGS. 9 and 10 are schematic diagrams depicting a brewing system and an associated brewing process according to some embodiments and implementations;

FIG. 11 is a perspective view of a brewing assembly according to yet another embodiment;

FIGS. 12-22 are cross-sectional views of the brewing assembly of FIG. 11 in various stages of a brewing process according to some implementations; and

FIG. 23 is a cross-sectional view of another brewing assembly according to other embodiments.

### DETAILED DESCRIPTION

It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure, but is merely representative of possible embodiments of the disclosure. In some cases, well-known structures, materials, or operations are not shown or described in detail.

Various embodiments of apparatus and methods are disclosed herein that relate to hot beverage brewers, such as coffee and/or tea brewers. Some embodiments disclosed herein may, for example, provide a plurality of chambers, which in some embodiments may be stacked upon one another to allow for gravity-controlled or at least gravity-assisted movement of liquid from one chamber to another. In some embodiments, a vacuum may be used to assist in movement of liquid from one chamber to another. In some such embodiments, at least one of the chambers may therefore comprise a vacuum chamber. In some embodiments, the vacuum chamber may be part of a container, such as a carafe, where the brewed beverage will ultimately be delivered following the brew process.

In some embodiments, the vacuum may also be used to actuate a valve for delivery of liquid from one chamber to another, such as from a brewing chamber to a delivery chamber following brewing of the beverage. In some such embodiments, the vacuum may also be used to assist in moving the liquid between chambers. However, alternatively, the vacuum may only be used to assist in moving the liquid between chambers, or may only be used to actuate a valve to facilitate such movement.

In some embodiments and implementations, the brew process may comprise a full immersion and/or the brewer may be configured to provide for a full immersion brewing of the beverage. In other words, the coffee or other brewing material is fully, or at least substantially fully, immersed in hot water or another liquid for most or all of the brewing process. However, unlike a typical French-press brewing approach, in preferred embodiments and implementations, the liquid may be delivered from one chamber to another, and ultimately to a carafe or other container, without requiring any manual steps, which may allow for providing a more consistent and repeatable brew and beverage.

In some embodiments, each of the various steps in the brewing process may proceed in a linear fashion, such as preferably from a top portion of the brewing machine to a carafe or other container at the bottom portion of the container. However, in certain batch or commercial embodiments, a separate pump or other fluid delivery means may be used to deliver water from a larger chamber, which may be set apart from the stacked assembly if desired, into one or more ports and/or shower heads positioned above a brewing chamber. In some embodiments, one or more (in some cases, all) of the steps in the brewing process may be visible to a user.

In some embodiments, the coffee, tea, or other brewing material may be placed in one chamber, such as brewing chamber. In some embodiments, a hot water/liquid shower head may be positioned above the brewing chamber to allow for delivery of heated water or another heated liquid over the brewing material. In some embodiments, a plurality of heads may be distributed (in some cases, evenly distributed) above the brewing chamber to allow for even application and/or distribution of the heated liquid over the brewing material.

In some embodiments, a chamber may be provided for receipt of the liquid. This liquid chamber may be removable and/or refillable in embodiments designed for home use. In other embodiments, such as commercial batch brewer embodiments, this chamber may be fixed and/or larger. In still other embodiments, which may also be more suitable for commercial use, this chamber may be removed from the stacked assembly and fluidly coupled with the brewing chamber to allow for delivery of hot water or another heated liquid into the brewing chamber.

For example, some preferred embodiments may comprise a liquid chamber that may be filled with water or another liquid. This chamber may be fluidly coupled with the brewing chamber and/or the liquid delivery heads. Thus, in some preferred embodiments, the liquid chamber may be positioned above the brewing chamber to allow for gravity-assisted delivery of hot water into the brewing chamber. This may remove the need for providing a pump for delivery of heated water into the brewing chamber. The liquid chamber may be configured with one or more heating elements such that the liquid may be heated to a desired temperature. Alternatively, the liquid delivered from the liquid chamber may be heated outside of the chamber such as during delivery of the liquid into the brewing chamber, for example. In some preferred embodiments, however, the device may be configured such that the liquid enters a brewing assembly from an upper portion and/or chamber of the assembly and travels downward toward a delivery chamber throughout the brew process, irrespective of whether the water is delivered to the upper chamber from another chamber placed at the upper end of the assembly or from a chamber elsewhere configured to deliver the water to the upper chamber.

In some embodiments and implementations, a pre-infusion step may be provided, or at least available to be programmed by a user, before later adding more water for full-immersion of the coffee/tea in the heated liquid. In some such embodiments, the pre-infusion step may also provide for pre-infusion agitation of the coffee or other brewing material. For example, some embodiments may be configured to deliver the heated liquid in a forceful manner to assist in agitation. Some such embodiments may therefore comprise a pump or other suitable means for forceful delivery of the heated liquid. Some embodiments may also, or alternatively, comprise one or more post-infusion steps, such as additional drawdown pulses designed to force floating coffee or other materials down towards a filter.

After the pre-infusion step or, in embodiments or implementations lacking such a step, after heating the liquid in and/or from the liquid chamber, the brewing chamber may be filled with the heated liquid, preferably to provide for full immersion brewing. In some embodiments, the brewing process in the brew chamber may then begin. In some embodiments, the device may be configured to provide a predetermined steep time. Alternatively, the device may be programmable and may allow a user to keep the beverage in the brewing chamber for a precise, predetermined amount of time according to taste and/or the beverage being brewed.

Once the steeping time has expired, preferably the pressure in another chamber, such as a beverage delivery chamber, is lowered, such as by applying a partial vacuum to the chamber. In some embodiments, the beverage delivery chamber may comprise a carafe/container chamber. Thus, in some embodiments, the vacuum may be applied to the container/carafe to ultimately force the finished beverage into the container that may be used to pour the beverage. Preferably the beverage delivery chamber is sealed with respect to the brewing chamber and/or the other chambers so that the brewing process can be more tightly controlled. For example, it may be preferred that the beverage be wholly, or at least substantially, prevented from passing from the brewing chamber to the beverage delivery chamber prior to expiration of the desired steeping time. In some embodiments and implementations, the vacuum/pressure differential may not only be used to open a valve, but may also be used to drive the finished beverage from the brewing chamber.

In some embodiments, this may be facilitated by providing one or more suitable valves between the beverage delivery chamber and the brewing chamber. For example, a passive valve, such as a spring-loaded and/or vacuum-actuated valve may be used in certain preferred embodiments. This valve may, for example, be positioned between the delivery and brewing chambers, such as below the brewing chamber in certain preferred stacked configurations. Thus, upon application of a suitable pressure differential, the valve(s) may be configured to automatically open to allow for passage of liquid between the brewing chamber and delivery chamber. Preferably, the delivery chamber is sealed from the brewing chamber prior to actuation of the vacuum and/or valve such that no liquid can be transferred between these two chambers prior to such actuation. In some embodiments, this seal may be created, at least in part, by use of a magnetic seal, such as by use of rare earth magnets, for example.

Although the most preferred embodiments disclosed herein utilize a vacuum, valve, and/or other means for precisely controlling delivery of a brewed beverage from a brewing chamber, it is contemplated that such a valve may be removed in other embodiments. For example, if full immersion brewing is not desired or needed, the valve may be removed and one or more of the embodiments disclosed herein may thereby be converted into an assembly configured for drip brewing instead. Alternatively, an electronically-operated valve may be used to control flow of brewed beverage or other fluids between the chambers.

Once brewed liquid has all been delivered into the carafe/delivery chamber, air may then be allowed to flow into the delivery chamber, thereby allowing for equalization of pressure and closure of the valve(s). In some embodiments, once the valve(s) has closed, the carafe/delivery chamber may be removed from the device to allow for pouring of the beverage as desired. Some embodiments may comprise a light and/or heating element, such as a suitable halogen lamp, to allow for keeping the beverage at a desired temperature following brewing.

Embodiments comprising a pump or other means for applying a pressure differential, in combination with one or more valves, as discussed above, may provide substantial benefits. For example, some such embodiments may allow a user to control the vacuum/pressure differential applied, which may allow for delivery of the beverage through filtration at a desired and/or controlled rate. This control may be enhanced by using spring-loaded valves, which may allow for precise control over delivery rates and/or other parameters by simply modifying the spring rate of the valve. This may facilitate avoiding having the beverage delivered too quickly through a filtration medium, which often leads to particulate pulling through to the finished beverage and creates undesirable flavors.

It may be preferable for some embodiments to use a valve that allows for precise control. Such control may be provided by, for example, embodiments utilizing a vacuum that may be selectively and directly applied at will rather than relying upon indirect application of low pressure through condensing steam, for example. Thus, by applying a pressure differential using a pump, for example, that is fluidly coupled with a vacuum chamber (which, as mentioned above, may be part of the beverage delivery chamber in some embodiments) a passive valve may be opened to allow for delivery of a brewed beverage from the brew chamber.

It may also be preferable to fluidly seal, or at least substantially fluidly seal, the brewing chamber from the vacuum chamber prior to actuation of the vacuum and/or valve rather than merely relying on a filter between the two chambers. Relying on a filter alone may be disadvantageous for some applications because it may allow for uneven steeping. For example, some steeped liquid may be allowed to exit the brewing chamber prior to being adequately infused with flavor, which may lead to undesirable and/or inconsistent flavors.

Some embodiments may also, or alternatively, allow for precise temperature control, which may be varied from batch to batch as desired in accordance with the brewing material and/or personal tastes. By incorporating temperature control, full immersion brewing, a finer/clean filtration, and/or a controlled draw-down rate of the beverage by use of pressure differentials and/or valves, as discussed above, a better beverage may be provided and, in some embodiments, users may be able to alter one or more brewing parameters as desired from batch to batch. In some embodiments, this control may be provided by incorporating a user interface that may allow for refinement control of, for example, brew temperatures, steeping times, pre-infusion steps, such as amounts of pre-steeping delivery of heated liquids and/or agitation steps, etc. In addition, some embodiments may be configured to allow for programming of specific recipes, which may incorporate one or more of the parameters listed below to allow a user to dial in a most preferred set of parameters for a particular beverage, save the “recipe” associated with such parameters, and be able to easily repeat it without requiring re-entry of each parameter manually.

To allow for further refinement of the coffee or other beverage delivered from the brewing device, some embodiments may be configured such that the water or other liquid used in the brewing process is prevented, or at least substantially prevented, from coming into direct contact with any plastic materials throughout the brew process. In some such embodiments, the device may be configured such that this liquid only contacts glass and/or stainless steel materials throughout the brew process, which may prevent undesirable flavors from being introduced into the finished beverage.

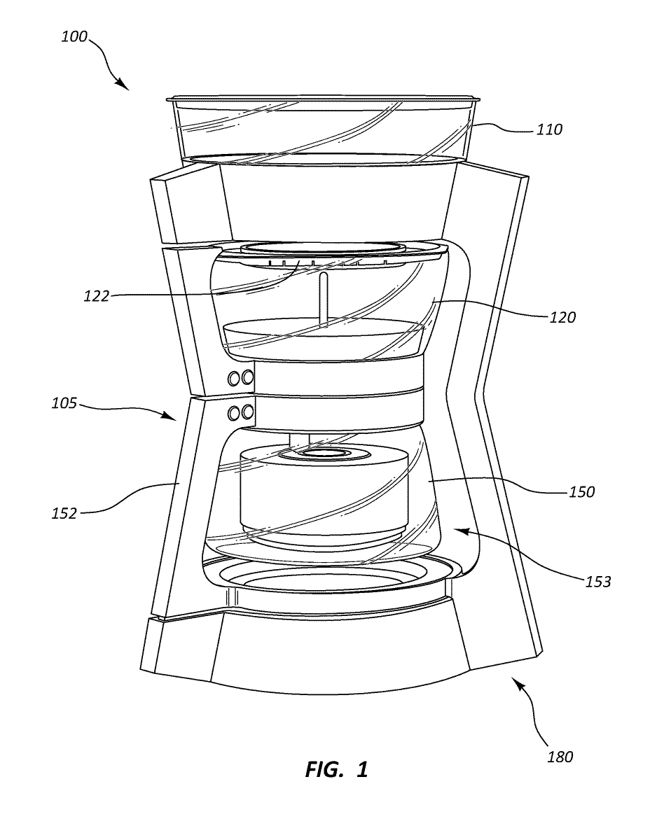

Additional details regarding certain preferred embodiments will now be described in greater detail with reference to the accompanying drawings. FIG. 1 depicts an example of a brewing assembly 100 comprising an assembly of stacked chambers. Brewing assembly 100 may be more suitable for use in a consumer's home, for reasons that will become apparent.

More particularly, brewing assembly 100 comprises a liquid chamber 110 positioned at the upper end of the assembly. A brewing chamber 120 is positioned below liquid chamber 110 and is fluidly coupled with liquid chamber 110. A delivery chamber 150 is positioned below brewing chamber 120. Delivery chamber 150 is fluidly coupled with brewing chamber 120. Preferably, delivery chamber 150 is also fluidly sealed, or at least substantially fluidly sealed, with respect to brewing chamber 120, at valve 140 (not visible in FIG. 1). As discussed in greater detail below, upon actuation of valve 140 by selective application of a pressure differential within delivery chamber 150, valve 140 is configured to open to allow for delivery of a finished, brewed beverage into delivery chamber 150. Thus, with respect to the depicted embodiment, delivery chamber 150 may also be considered a vacuum chamber.

Valve 140 may comprise a manual valve, a passive valve, such as a vacuum-actuated valve, or an electronic valve. In some preferred embodiments, valve 140 comprises a spring-loaded, passive valve that may be actuated by application of a pressure differential. Alternatively, valve 140 may otherwise comprise an energized valve that is configured to keep all, or at least substantially all, of the brewed/brewing liquid within a brewing chamber until application of a suitable pressure differential or vacuum, after which the “energization” (spring or otherwise) of the valve may be overcome by the energy from the pressure differential.

As previously mentioned, in some embodiments, valve 140 may be actuated by selective application of a vacuum or pressure differential or, alternatively, valve 140 may comprise another type of valve but a vacuum or pressure differential may still be applied in order to assist in movement of the brewed beverage between brewing chamber 120 and delivery/vacuum chamber 150.

Brewing assembly 100 further comprises a vacuum tube 155 (not visible in FIG. 1), which may extend from a suitable pump and terminate within delivery/vacuum chamber 150. Preferably, vacuum tube 155 extends through a portion of a frame 105 of brewing assembly 100 such that it can be hidden from view and can avoid being damaged by a user during use. In the depicted embodiment, vacuum tube 155 extends through a handle 152 of a carafe 153 defining delivery/vacuum chamber 150.

In some embodiments, this carafe may be removable from the assembly 100. Thus, in some such embodiments, the carafe 153 may be configured such that it must be positioned within a particular rotational orientation with respect to the rest of assembly 100 before the brewing process may take place. More particularly, and as discussed in greater detail below, the vacuum tube 155 may comprise a port configured to provide a fluid seal with another port to allow for application of a suitable vacuum to actuate valve 140. In some embodiments, a particular rotational orientation between carafe 153/vacuum chamber 150 and one or more other elements of assembly 100, such as base 180, is needed in order to allow for these ports to align and fluidly seal.

Base 180 may be positioned at the lower end of brewing assembly 100, which may house various functional components of the assembly, such as lights, heating elements, vacuum ports, pumps, electrical couplers, etc. These aspects of the assembly 100 will be discussed in greater detail below.

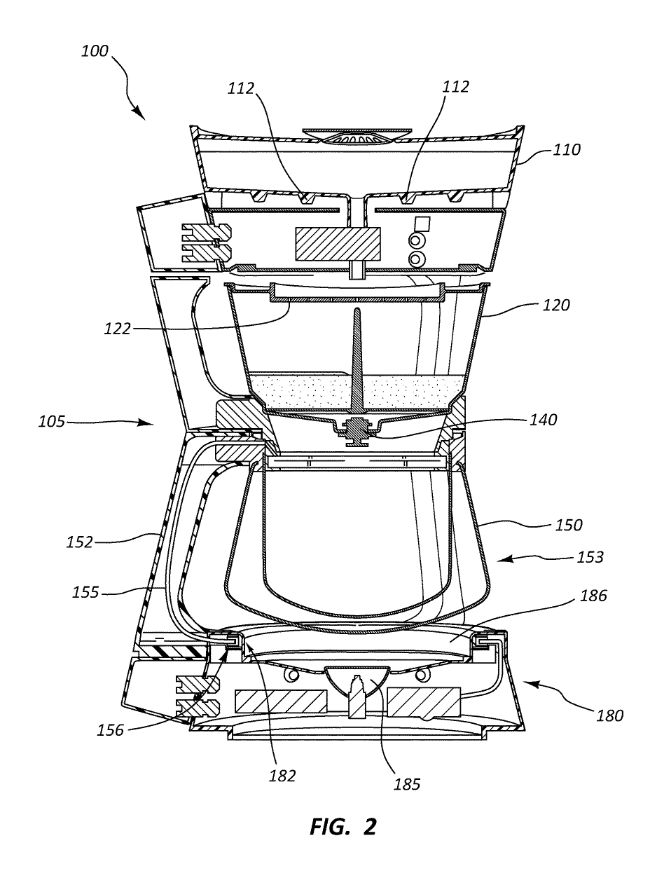

FIGS. 2-5 depict brewing assembly 100 in various stages of a brewing process according to some implementations of preferred methods. Liquid chamber 110 may be configured to receive and/or store water or another liquid used in the brew process. In some embodiments, liquid chamber 110 may be removable from assembly 100. Alternatively, liquid chamber 110 may comprise a lid, cap, and/or opening to allow for receipt of a suitable liquid therein.

In some embodiments, liquid chamber 110 may be positioned adjacent to one or more primary heating elements 112, which may allow for heating of the liquid to a desired temperature. In some embodiments, heating elements 112 may be precisely controlled to allow for adjustment of the desired heating temperature by a user. Thus, one or more temperature sensors may be provided, which may be used to deliver temperature data to suitable electronic elements in a feedback loop, for example, to allow for monitoring and precisely controlling temperature.

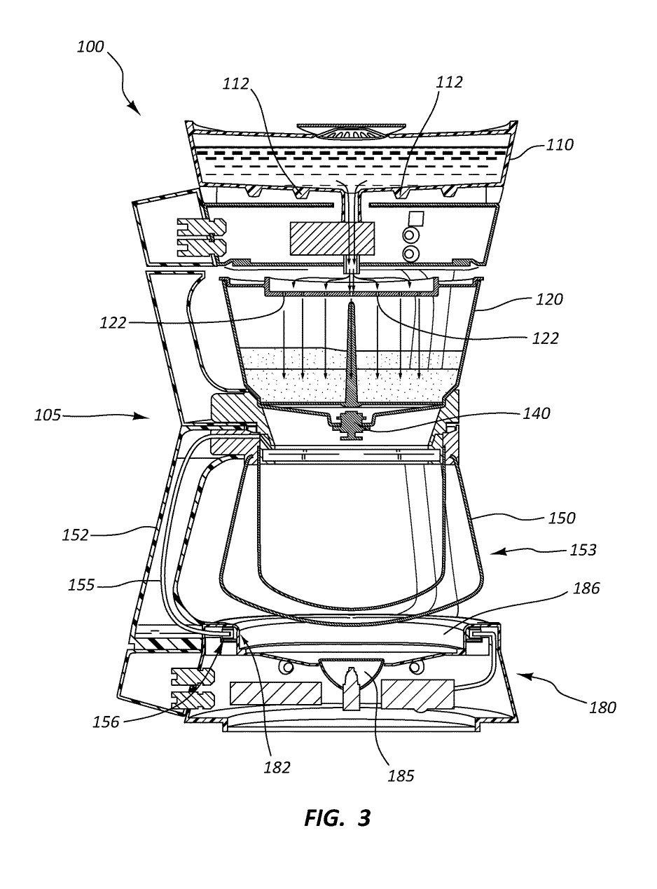

After the liquid has reached the desired temperature, it may be delivered to brewing chamber 120 positioned below the liquid chamber 110, as shown in FIG. 3. In some embodiments, one or more ports, such as a plurality of ports 122, may be used to deliver heated liquid to the brewing chamber 120. In some embodiments, assembly 100 may be configured to deliver a desired dose of heated liquid to brewing chamber 120 all at once. However, other embodiments may be configured to deliver heated liquid in an initial pre-infusion step prior to delivery of a full brewing dose of the liquid. For example, in some embodiments and implementations, one or more of ports 122 may be configured to deliver short bursts of heated water, steam, or other fluid for pre-infusion and/or agitation. In some embodiments, the pre-infusion stage of the brewing process may be controllable by the user. For example, a user may be allowed to select the intervals, durations, force, ports, etc., for delivery of heated liquid in the pre-infusion step.

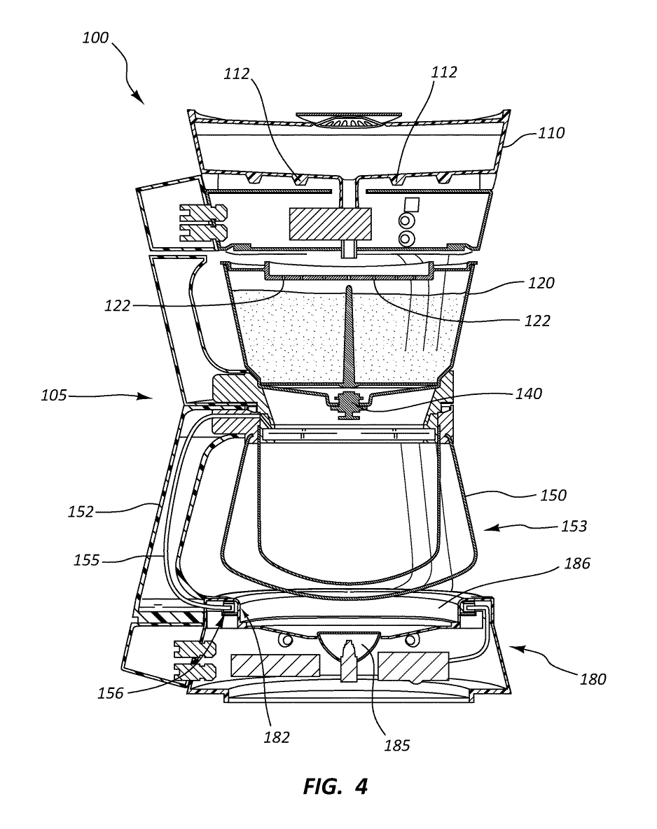

In embodiments and implementations comprising pre-infusion, following such pre-infusion, a desired amount of heated liquid may be delivered into brewing chamber 120, preferably to allow for full immersion of the coffee or other brewing material in the heated liquid, as shown in FIG. 4. In some embodiments, the brewing assembly 100 may be configured to provide a predetermined steep time. Alternatively, the brewing assembly 100 may be programmable and may allow a user to keep the beverage in the brewing chamber for a precise, predetermined amount of steeping time according to taste and/or the beverage being brewed.

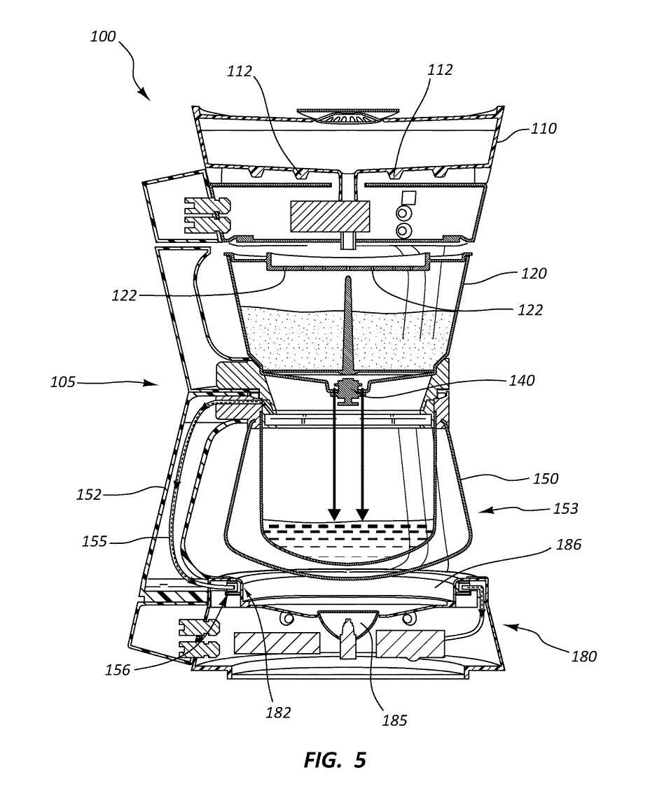

Once the preferred steeping time has expired, the pressure in delivery/vacuum chamber 150 is lowered. This may be accomplished by applying a partial vacuum to delivery/vacuum chamber 150 through vacuum tube 155, which may be coupled with delivery/vacuum chamber 150 so as to allow for application of a vacuum/pressure differential in delivery/vacuum chamber 150 with respect to brewing chamber 120. Valve 140, which may comprise a passive, spring-loaded valve or another suitable valve, may be configured such that a predetermined pressure differential will open valve 140. Thus, upon application of such a predetermined pressure differential, valve 140 will automatically open to allow for passage of the brewed beverage from the brewing chamber 120 to the delivery chamber 150, as shown in FIG. 5. Alternatively, valve 140 may comprise an electronic or other actively-controlled valve and a pressure differential may be applied simultaneously with actuation of valve 140, or immediately following actuation of valve 140, in order to assist with liquid draw down.

Preferably, the delivery chamber 150 is fluidly sealed from the brewing chamber 120 prior to actuation of the valve 140 such that no liquid can be transferred between these two chambers prior to such actuation, which may provide an improved and/or more consistent beverage flavor. This may be accomplished by aligning a first vacuum port 156 with a second vacuum port 182 such that they are fluidly sealed and coupled with one another. In the depicted embodiment, vacuum port 156 is positioned at a terminal end of carafe handle 152 and vacuum port 182 is positioned in base 180. Thus, in some embodiments, it may be necessary to align vacuum port 156 with vacuum port 182 by rotationally aligning carafe 153 with respect to base 180 and/or frame 105 to accomplish this sealing. However, other embodiments are contemplated in which delivery chamber 150 need not be removable, in which case this realignment would not be necessary.

A heating element 185, such as a halogen lamp, may be positioned adjacent to delivery chamber 150 to maintain a desired beverage temperature following brewing. As discussed below, heating element 185 may also, or alternatively, comprise a light source to enhance the visualization of the extraction/brewing process if desired. In some embodiments, a hot plate 186 or other heat conductive member may be positioned within base 180 to allow for distribution of heat from heating element 185. Alternatively, heat may be delivered electronically from hot plate 186 and heating element 185 omitted if desired.

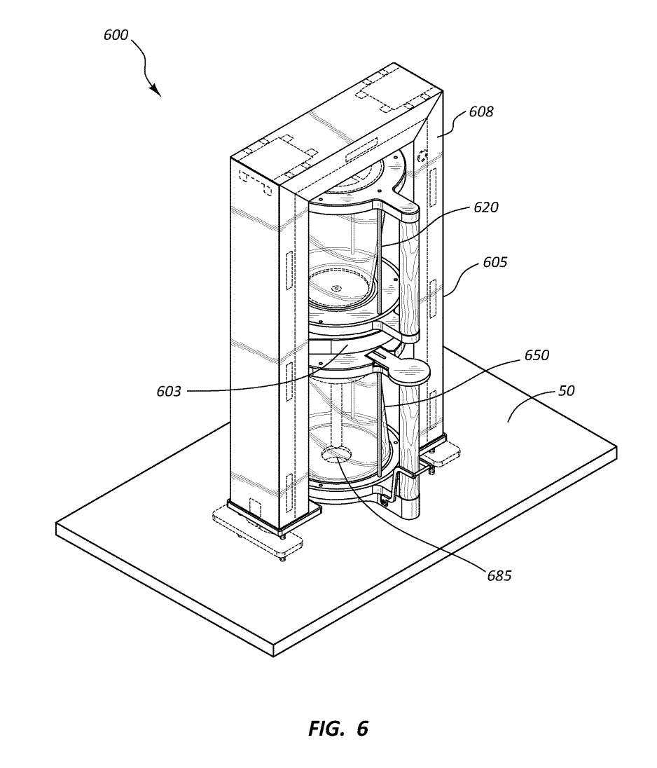

FIG. 6 depicts a perspective view of another embodiment of a brewing assembly 600, again comprising an assembly of stacked chambers. Brewing assembly 600 may be more suitable for commercial use, such as for use in batch brewing, for reasons that will become apparent.

More particularly, brewing assembly 600 comprises a brewing chamber 620 positioned at an upper end of the assembly. Thus, unlike brewing assembly 100, brewing assembly 600 may comprise a liquid chamber (not shown) that may be positioned elsewhere, such as below table top 50. Liquid from such chamber may then be delivered into brewing chamber 620 by using one or more pumps or other suitable means for delivery of liquid. In embodiments in which a liquid chamber is positioned above brewing chamber 620, such liquid may be delivered by simply opening a valve and allowing gravity to transfer liquid into the brewing chamber.

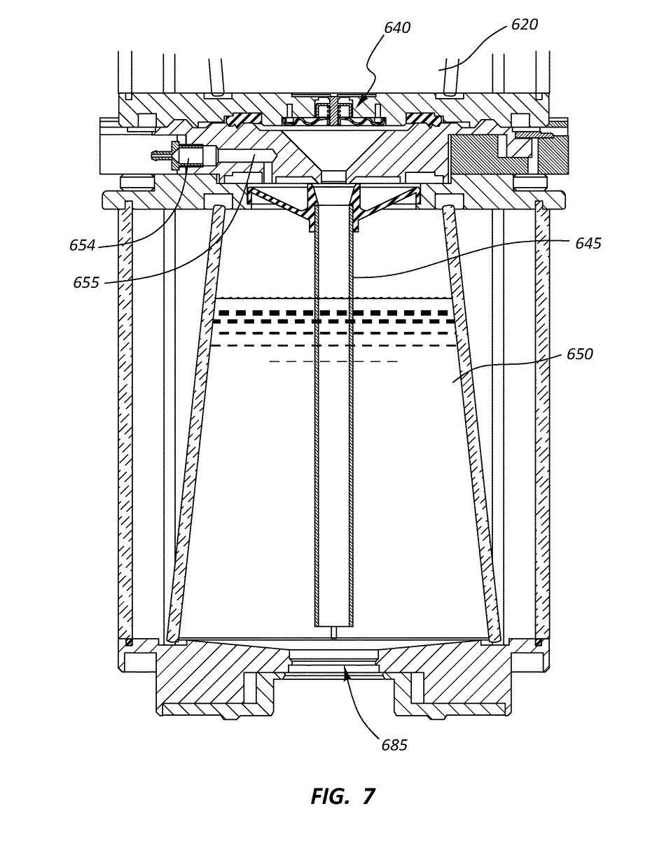

A delivery chamber 650 is positioned below brewing chamber 620. Delivery chamber 650 is fluidly coupled with brewing chamber 620. Preferably, delivery chamber 650 is also fluidly sealed, or at least substantially fluidly sealed, with respect to brewing chamber 620, at valve 640 (not visible in FIG. 6). As discussed in greater detail below, upon actuation of valve 640 by selective application of a pressure differential within delivery chamber 650, valve 640 is configured to open to allow for delivery of a finished, brewed beverage into delivery chamber 650. Thus, with respect to the embodiment depicted in FIGS. 6 and 7, delivery chamber 650 may also be considered a vacuum chamber. However, as previously mentioned, delivery chamber 650 may be considered a vacuum chamber even if this pressure differential is applied in order to assist in movement of liquid between brewing chamber 620 and delivery chamber 650 without serving to actuate valve 640.

Valve 640 may comprise a manual valve, a passive valve, such as a vacuum-actuated valve, or an electronic valve. In some preferred embodiments, valve 640 comprises a spring-loaded, passive valve that may be actuated by application of a pressure differential. Alternatively, valve 640 may otherwise comprise an energized valve that is configured to keep all, or at least substantially all, of the brewed/brewing liquid within a brewing chamber until application of a suitable pressure differential, after which the “energization” (spring or otherwise) of the valve may be overcome by the energy from the pressure differential.

As another alternative, in some embodiments, valve 640 may comprise a three-way valve. More particularly, in some such embodiments, the three-way valve may comprise three configurations: a first open configuration in which the brewing chamber may be open or fluidly coupled with respect to the delivery chamber/carafe; a second open configuration in which the brewing chamber is may be open or fluidly coupled with respect to another element of the assembly, such as a drain and/or drain line (for example drain 1190 and drain line 1192 with respect to brewing assembly 1100); and a closed configuration in which the brewing chamber may be closed with respect both the delivery chamber and the drain, drain line, or other element. This may be used to increase the efficiency of draining during a cleaning/draining/washing cycle, and may allow for further automation of a cleaning/draining/washing cycle.

Brewing assembly 600 further comprises a frame 605, which may serve to support brewing chamber 620 and delivery chamber 650. More particularly, frame 605 may comprise a superstructure 608, which may extend along one side of brewing chamber 620 and delivery chamber 650, across the top of brewing chamber 620, and down the opposite side, as shown in FIG. 6. Superstructure 608 may comprise one or more lumens or orifices for receipt of various functional elements therethrough, such as tubing for delivery of water, tubing for application of vacuums, various pistons, pumps, or other elements for application of such vacuums, etc. Frame 605 may further comprise a support base 603, which may extend between opposite sides of superstructure 608 and in between brewing chamber 620 and delivery chamber 650.

Brewing assembly 600 may function in a similar manner to brewing assembly 100 following introduction of a liquid, such as hot water, into brewing chamber 620. In particular, after a desired amount of heated liquid has been delivered into brewing chamber 620, preferably to allow for full immersion of the coffee or other brewing material in the heated liquid, brewing assembly 600 may be configured to allow for brewing in a predetermined steep time. Alternatively, brewing assembly 600 may be programmable and may allow a user to keep the beverage in the brewing chamber for a precise, predetermined amount of steeping time according to taste and/or the beverage being brewed.

Once the preferred steeping time has expired, the pressure in delivery/vacuum chamber 650 is lowered. This may be accomplished by applying a partial vacuum to delivery/vacuum chamber 650 through one or more vacuum tubes. In some embodiments, these vacuum tubes may extend through frame 605, such as through superstructure 608 and/or support base 603. This may allow for the needed equipment to create the required pressure differential to be placed out of view of a user, such as below table top 50.

As shown in the cross-sectional view of FIG. 7, valve 640 may be positioned adjacent to delivery/vacuum chamber 650 and in between brewing chamber 620 and delivery/vacuum chamber 650. Valve 640 may also be fluidly coupled with delivery/vacuum chamber 650, such that a suitable pressure differential applied to brewing chamber 650 causes valve 640 to open to allow for delivery of a brewed beverage from brewing chamber 620 into delivery chamber 650.

In the depicted embodiment, a separate vacuum valve 654 may be provided, which may allow for application of a pressure differential through vacuum tube 655 and into delivery/vacuum chamber 650. Vacuum valve 654 and vacuum tube 655 are positioned within support base 603 and again, are preferably fluidly coupled with delivery/vacuum chamber 650 so as to create a fluid-tight seal such that, upon application of a suitable pressure differential, valve 640 will automatically open to dispense liquid from brewing chamber 620 therethrough. As previously mentioned, valve 640 may comprise a passive, spring-loaded valve, electronic valve, three-way valve, and/or another suitable valve, may be configured such that a predetermined pressure differential will open valve 640. Preferably, delivery chamber 650 is fluidly sealed from brewing chamber 620 prior to actuation of valve 640 such that no liquid, or at least substantially no liquid, can be transferred between these two chambers prior to actuation of valve 640.

In some embodiments, one or more of the chambers may be removable from the assembly. For example, in brewing assembly 600, delivery chamber 650 may be removable from the assembly, and, in some embodiments, may be usable as a carafe to dispense coffee or another brewed beverage therefrom. In some embodiments, brewing chamber 620 may also, or alternatively, be removable. This may facilitate the addition of coffee and/or other brewing material to the assembly between batches.

As with assembly 100, in some embodiments, assembly 600 may be configured such that one or more (in some cases, each) of the various brewing stages is visible during the brewing process. For example, in the depicted embodiment, brewing chamber 620 and delivery chamber 650 may be made up of glass or another transparent material. In some embodiments, various transparent tubes may be provided to allow a user to visualize other stages during the brew process, such as the delivery of liquid into brewing chamber 620 and/or the extraction of the brewed beverage from brewing chamber 620 to delivery chamber 650.

For example, in the depicted embodiment, an extraction tube 645 may be added to enhance visualization of the extraction process. Extraction tube 645 may be fluidly coupled to brewing chamber 620 and/or valve 640. In some embodiments, extraction tube 645 may extend a substantial distance into delivery chamber 650. In fact, in some embodiments, extraction tube 645 may extend nearly the entire distance between the top end and the bottom end of delivery chamber 650 such that it almost touches the bottom surface of delivery chamber 650, as shown in the figures. By extending the extraction tube 645 in this manner, assembly 600 may be configured to enhance visualization of the brewed beverage extraction process. In some embodiments, a light source 685 may be provided at the bottom end of delivery chamber 650. In such embodiments in which extraction tube 645 is extended near a bottom end of delivery chamber 650, by aligning light source 685 with extraction tube 645, light from the light source 685 may extend through extraction tube 645 and/or the brewed beverage being delivered therethrough to further enhance the visualization of the process. In some embodiments, light source 685 may further comprise a source of heat, such as a halogen lamp, to not only enhance visualization but also to maintain the beverage at a desired temperature following brewing.

Of course, other embodiments are contemplated in which extraction tube 645 may be shortened, or omitted entirely. For example, in some embodiments, by configuring the coffee stream and/or lighting in a particular manner, the brewed beverage may be illuminated even without providing a tube.

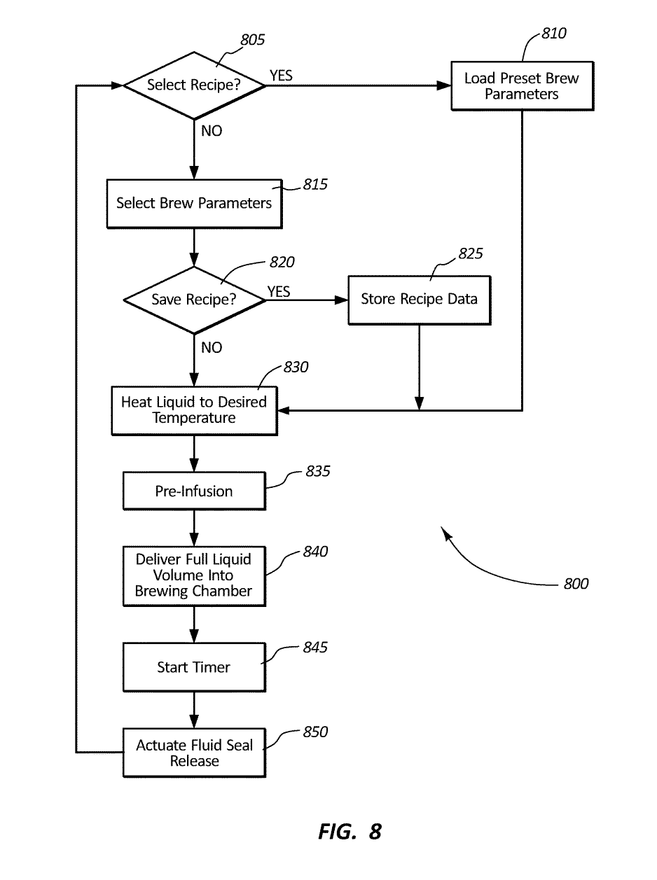

FIG. 8 is a flow chart illustrating an example of a brewing method 800 according to some implementations. As shown in this flow chart, method 800 may begin at step 805, at which point a user may be prompted to select a saved and/or pre-programmed brewing recipe. As mentioned above, such recipes may comprise various parameters for brewing a desired beverage according to the beverage type and/or personal preference, including, for example, liquid temperature, steeping time, pre-infusion steps and/or related parameters, etc.

If a user selects an existing recipe, method 800 may proceed to step 810, at which the related brewing parameters may be loaded or otherwise readied for application. If an existing recipe does not exist, or the user wishes to customize a new recipe, method 800 proceeds from step 805 to 815, at which point a user may be prompted or otherwise allowed to select one or more desired brewing parameters. After selecting such parameter(s), method 800 may proceed to step 820, at which point the user may be prompted to save the parameter(s) as a new recipe. Of course, in alternative implementations, the recipe may be automatically saved, or the method may proceed to other steps without allowing for saving of the recipe. If the user selects to save the brewing parameters as a new recipe, method 800 may proceed to step 825 at which point the data associated with the parameter(s) may be stored as a new recipe for later use.

If the user does not desire to save the recipe, if a user has loaded a preset recipe, or if the method does not allow for selecting parameters and/or saving recipes, the water or other liquid may be heated to a desired temperature at 830. In embodiments utilizing recipes and/or parameter selection, the liquid may be heated to a desired/selected temperature at step 830. In other implementations, the liquid may be heated to a standard, predetermined temperature at step 830. In still other implementations, the liquid need not be heated (in applications in which a cold beverage may be desired or acceptable).

In some implementations, one or more pre-infusion steps may then be performed at step 835. For example, in some implementations, the coffee or other brewing material may be agitated and/or stirred prior to full immersion. In some implementations, this may be done by forcefully squirting water into the brewing material in certain desired sequences, for example.

More particular examples of pre-infusion steps according to various embodiments and/or implementations are as follows. In some embodiments and/or implementations, one or more of these pre-infusion steps may be customizable by a user. For example, users may be able to adjust one or more (in some cases, all) of the following parameters.

In some embodiments and implementations, a pre-wetting step may be provided and/or customizable. This step may allow a user to deliver an initial amount of water/liquid to de-gas the coffee/brewing material, which may remove unwanted flavors from the brewing material. In some embodiments and implementations, the amount of pre-wetting may be selectable. For example, some embodiments and implementations may allow a user to select an amount of liquid used for pre-wetting, which may be as a percentage of the overall liquid that will ultimately be used for steeping. For example, some embodiments and implementations may allow a user to select any amount within a particular range (such as 0% to 50%) for pre-wetting.

In some embodiments and implementations, a pre-wetting delay may be implemented, which may allow for the desired pre-wetting liquid to sit within the brewing material in the brewing chamber for a desired period of time before additional liquid is introduced for full brewing. In some such embodiments and implementations, the pre-wetting delay may also, or alternatively, be customizable. For example, some embodiments and implementations may allow for selection of a pre-wetting delay period between, for example, 0 seconds (no delay) and sixty seconds or more. The amount of delay may depend, at least in part, on the amount of brewing material used. Thus, commercial embodiments may have a larger predetermined pre-wetting delay period, or may be configured to allow for selection of a larger pre-wetting delay period by a user.

In some embodiments and implementations, a steeping time may also be selectable by a user. However, in some such embodiments, a total “brew time” may be selectable by a user, which brew time may encompass one or more of the pre-infusion steps (in some cases, each of the pre-infusion steps). For example, in some embodiments and implementations, increasing the brew time may also result in an automatic increase in one or more (or all) of the timed pre-infusion steps. Thus, the full immersion steep time may be computed by subtracting all of the other steps, such as all of the pre-infusion steps, from the total brew time.

Following pre-infusion or, in implementations lacking a pre-infusion step, method 800 may then proceed to step 840 for full immersion of the brewing material by heated liquid within the brewing chamber. As soon as the heated liquid has been delivered, or begun to be delivered into the brewing chamber, a steeping timer may be initiated at step 845. In embodiments comprising recipes or otherwise allowing for selection of brewing parameters, the steeping timer may be altered as desired by a user. In alternative implementations, however, it should be understood that, rather than applying a timer, step 840 may comprise another means for selecting a steeping time. For example, in some implementations, one or more sensors may be used. For example, in some such implementations, a temperature sensor may be used and, upon detecting a predetermined change in temperature during steeping, the temperature sensor, rather than a timer, may be used to indicate termination of steeping.

Some embodiments and implementations may also comprise one or more post-infusion brew steps. For example, some embodiments may be configured to provide for one or more “knockdown” pulses of liquid following steeping. This step may allow for forcing brewing material that may be floating on top of the brewed/brewing beverage down towards the filter, which may further improve flavor according to certain tastes. In some such embodiments and implementations, this post-infusion step(s) may be performed right before and/or during delivery of the brewed beverage into a suitable chamber/container, as described below.

In some such embodiments and implementations, this post-infusion step(s) may also be customizable. For example, a user may be able to select a percentage of the overall liquid used in brewing (such as, for example, between 0 and 50%) that will be used in knockdown pulsing and/or select the number and/or intensity of such pulses.

In some embodiments and implementations, a post-knockdown pulse delay may also be provided. In some such embodiments, this delay time may also be selectable by a user. For example, some embodiments may allow for selection of a knockdown pulse delay of between 0 seconds and sixty seconds or more prior to opening the valve to allow for delivery of the finished beverage into a suitable carafe/delivery chamber.

In some embodiments and implementations, the total “brew time,” as discussed above, may encompass both pre-infusion and post-infusion steps. Thus, adjustment of the total brew time may automatically result in a corresponding adjustment, on a percentage basis for example, of all of the other timing parameters.

Upon detection of a termination in desired steeping time and/or post-infusion steps, method 800 may then proceed to step 850 for delivery of the finished, brewed beverage into a suitable container/chamber, which may be done by actuation of a suitable fluid seal release mechanism. For example, in preferred implementations, step 850 may comprise actuation of a pump or other means for applying a pressure differential, which may result in opening of a valve positioned between a brewing chamber and a delivery chamber.

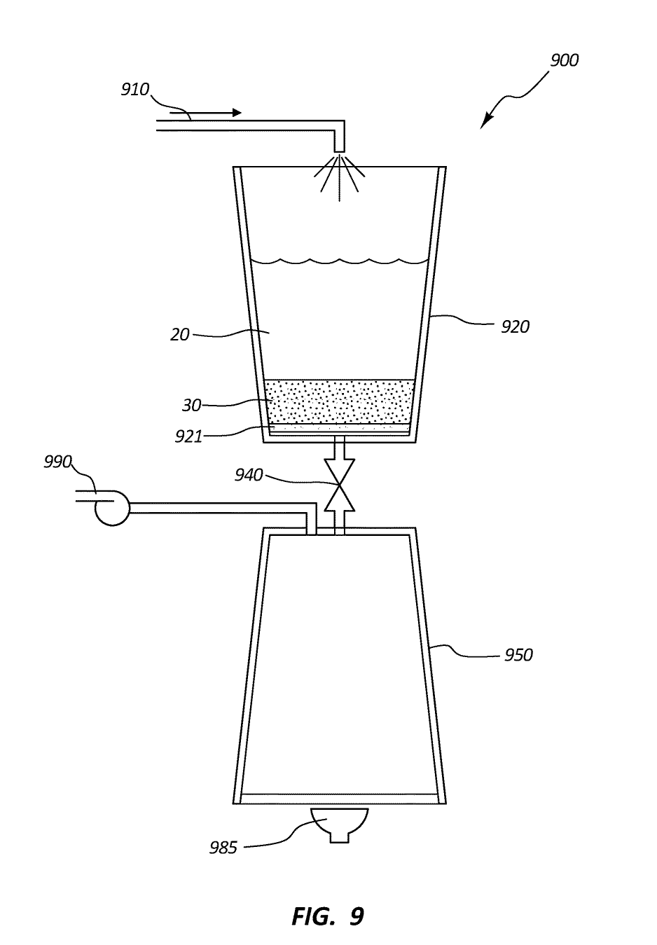

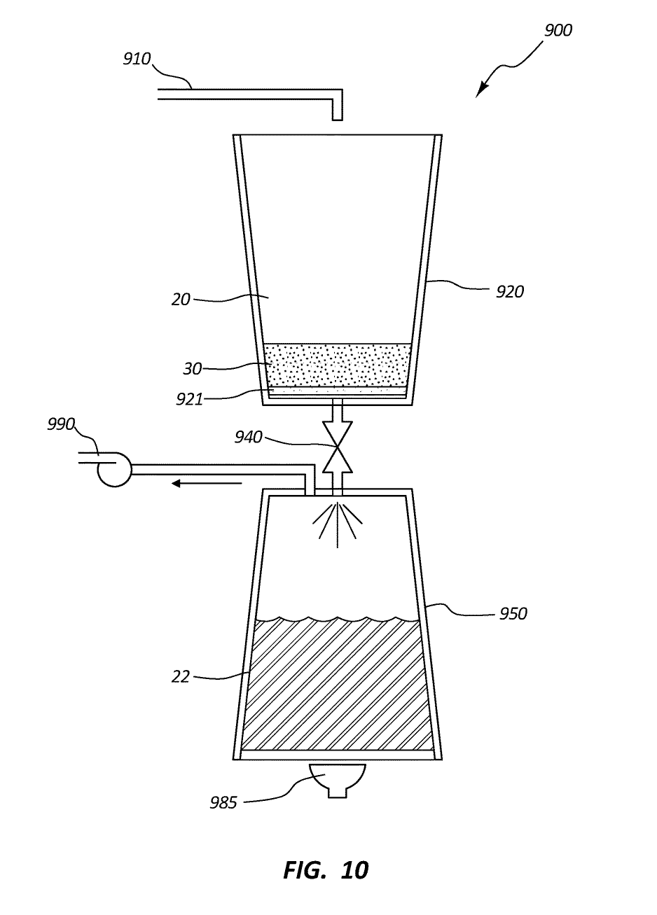

FIGS. 9 and 10 are schematic diagrams depicting more general applications of some of the inventive principles presented above. More particularly, FIG. 9 depicts a schematic representation of a brewing system 900. Brewing system 900 comprises a means 910 for delivery of a liquid, such as hot water or another heated liquid, into a brewing chamber 920. As previously mentioned, in some embodiments, liquid delivery means 910 may comprise a liquid chamber, which, if positioned above brewing chamber 920, may allow for delivery of a suitable liquid 20 into brewing chamber 920 by use of gravity and a valve. Alternatively, liquid delivery means 910 may comprise a pump or other suitable mechanical means for forcing liquid into brewing chamber 920. In some such embodiments, a liquid chamber may be positioned elsewhere, such as under a counter, behind a cabinet, etc.

Ground coffee, tea, or other brewing material 30 may be positioned in brewing chamber 920, along with a filter 921. Filter 921 may comprise a filter configured to be replaced with every brew, such as a paper filter, or may comprise a more permanent filter configured to be left in place over the course of several brews, such as a metal filter, or a combination of the two. Upon expiration of a desired steeping time, a valve 940 may be opened to allow for delivery of a brewed beverage 22 into a carafe and/or delivery chamber 950, as depicted in FIG. 10.

In some embodiments, as described elsewhere herein, another valve may be provided in delivery chamber 950 to allow for dispensing of the finished, brewed beverage therethrough. However, in some embodiments, this valve may be omitted and delivery chamber 950 may instead be removed from the assembly and delivered from an opening in the top of delivery chamber 950.

Valve 940 may comprise a manual valve, a passive valve, such as a vacuum-actuated valve, or an electronic valve. In some embodiments, valve 940 may comprise a three-way valve, which, as discussed elsewhere herein, may allow for improved functionality in the way of self-cleaning and/or draining. In some preferred embodiments, valve 940 comprises a spring-loaded, passive valve that may be actuated by application of a pressure differential. Alternatively, valve 940 may otherwise comprise an energized valve that is configured to keep all, or at least substantially all, of the brewed/brewing liquid within a brewing chamber until application of a suitable pressure differential, after which the “energization” (spring or otherwise) of the valve may be overcome by the energy from the pressure differential.

In preferred embodiments, valve 940 is opened by actuation of a vacuum pump 990, which is coupled with delivery chamber 950, and/or or brewed beverage is forced into delivery chamber 950 by actuation of vacuum pump 990. Thus, in such embodiments, delivery chamber 950 may also be considered a vacuum chamber. Upon creating a sufficient pressure differential, valve 940 may be automatically opened, which may not only allow for delivery of the brewed beverage 22 into delivery chamber 950, but may also assist in drawing the beverage into delivery chamber 950. A light 985 may be positioned under the delivery chamber/carafe 950, which may facilitate a desired illumination of the brewing and/or extraction process and, in some embodiments, may also, or alternatively, provide a heat source for maintaining the brewed beverage 22 at a desired temperature after brewing.

In some embodiments and implementations, multiple, separate extractions and/or steepings may be provided, or allowed as an optional parameter. For example, in some embodiments, a user may be allowed to select an option that allows for dividing the total liquid into various fractions, such as ½, ⅓, etc., for double, triple steeping. Thus, in some such embodiments, a first steeping may be performed and extracted, following by a second steeping and extraction, etc. Providing such an option may be desirable to “wash” the brewing material, and may be particularly useful in connection with certain tea brew materials. In some such embodiments, a delay may be provided, which delay may also be adjustable, in between the various steepings. As yet another option, some embodiments may allow for selection/programming of a pause in between one or more of the steepings/extractions, such that a user can, if desired, dump the first steeping so that it is not mixed with the subsequent steeping(s). For example, in some such embodiments, a user may be required to manually resume the brewing so that brewed beverage is not delivered into an empty base without a delivery chamber/carafe. Alternatively, the assembly may be configured to detect the presence of the delivery chamber/carafe and may automatically resume the brewing process upon detecting the presence of the delivery chamber/carafe. Of course, for many tastes and/or brewing materials, users may not prefer to dump any of the brewed beverage from any of the various steepings. Thus, some embodiments and implementations may be configured to simply steep and/or extract each of the separate divisions of a full brew into the same container such that they mix together.

In some embodiments, the assembly may be configured to optionally deliver the aforementioned “wash” cycles, either as an alternative or in addition to rinse liquids, into a separate drain line. In some such embodiments, this may be accomplished by use of a three-way valve, which valve may comprise three configurations: a first open configuration in which the brewing chamber may be open or fluidly coupled with respect to the delivery chamber/carafe; a second open configuration in which the brewing chamber is may be open or fluidly coupled with respect to another element of the assembly, such as a wash or drain line; and a closed configuration in which the brewing chamber may be closed with respect both the delivery chamber and the drain, drain line, wash, wash line, or other element. This may be used to increase the efficiency of draining during a cleaning/draining/washing cycle, and may allow for further automation of a cleaning/draining/washing cycle. Thus, during each “wash” cycle, the three-way valve may be opened to the second open configuration to allow liquids to be delivered to a wash line, which may be coupled with a drain line to allow for dumping of such liquids. Alternatively, such liquids may be delivered into the delivery chamber if desired.

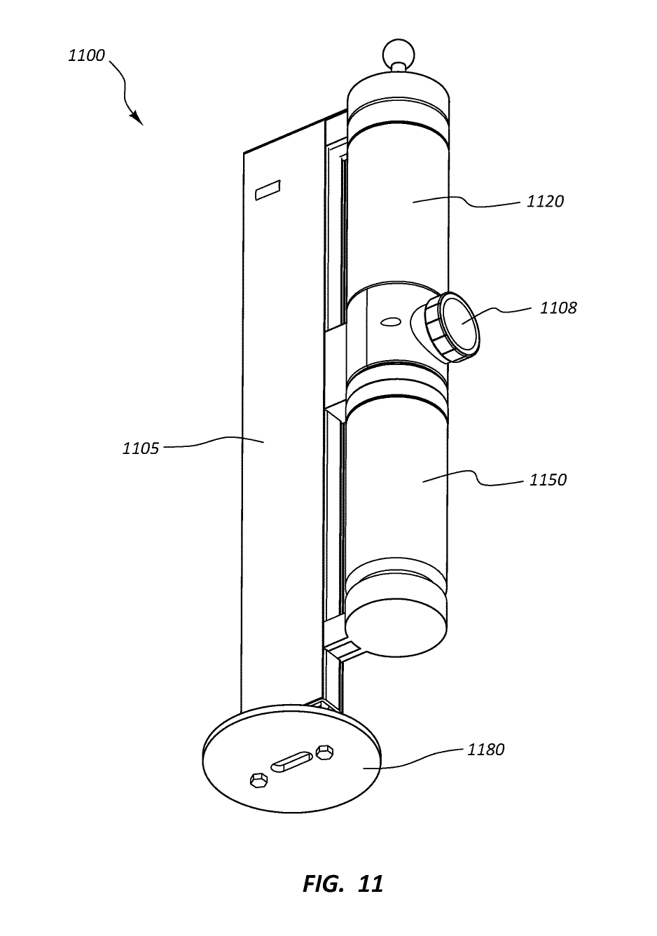

FIG. 11 illustrates yet another embodiment of a brewing assembly 1100. Brewing assembly 1100 may be more suitable for use as a commercial brewer. However, those of ordinary skill in the art will appreciate that, with certain modifications, brewing assembly 1100 may be reconfigured for use as a home brewer.

More particularly, brewing assembly 1100 comprises a brewing chamber 1120 positioned at the upper end of the assembly and a delivery chamber 1150 positioned below brewing chamber 1120. Delivery chamber 1150 is fluidly coupled with brewing chamber 1120. Preferably, delivery chamber 1150 is also fluidly sealed, or at least substantially fluidly sealed, with respect to brewing chamber 1120. For example, as previously mentioned, one or more valves (not visible in FIG. 11) may be provided in between brewing chamber 1120 and delivery chamber 1150 that may allow for delivery of fluid between these two chambers. For example, as previously discussed, upon actuation of a vacuum-controlled valve by selective application of a pressure differential within delivery chamber 1150, brewed beverage may be delivered into delivery chamber 1150. Thus, with respect to the depicted embodiment, delivery chamber 1150 may also be considered a vacuum chamber.

Brewing assembly 1100 further comprises a frame 1105 and a base 1180. As shown in FIG. 11, frame 1105 may be configured to allow the various components, such as brewing chamber 1120 and delivery chamber 1150, to be coupled to one another as an assembly. Base 1180 may be provided to provide stability in positioning brewing assembly 1100 on a table, countertop, or the like. In certain commercial brewing embodiments, base 1180 may comprise one or more openings configured to allow for passage of various tubes, ports, lines, or the like for delivery of, for example, water, steam, air, or other fluids used during operation of brewing assembly 1100. More particularly, in some embodiments, a boiler, tanks, control valves, and/or other control elements may be positioned below base 1180, such as in a cabinet or the like positioned below base 1180.

As also shown in FIG. 11, brewing assembly 1100 further comprises a control display/user interface 1108. User interface 1108 may be used to allow a user to operate the device. In some embodiments, as previously explained, user interface 1108 may be used to allow a user to program specific recipes, which may incorporate one or more of the parameters discussed above, to allow a user to dial in a most preferred set of parameters for a particular beverage, save the “recipe” associated with such parameters, and be able to easily repeat it without requiring re-entry of each parameter manually.

In some embodiments, one or more features/components may be used to allow for selective release and/or locking of delivery chamber 1150 in place. In this manner, delivery chamber 1150 may be removed from brewing assembly 1100 and used to pour coffee or another brewed beverage into other containers. In some embodiments, delivery chamber 1150 may be removed and used as a single-serve container. In some such embodiments, delivery chamber 1150 may be disposable or at least replaceable with another similar delivery chamber 1150. Thus, for example, in some embodiments, delivery chamber 1150 may be used to receive the brewed beverage and then may be delivered to a customer and/or consumer in the same container for consumption and then replaced with a new delivery chamber or other similar container for subsequent brewing.

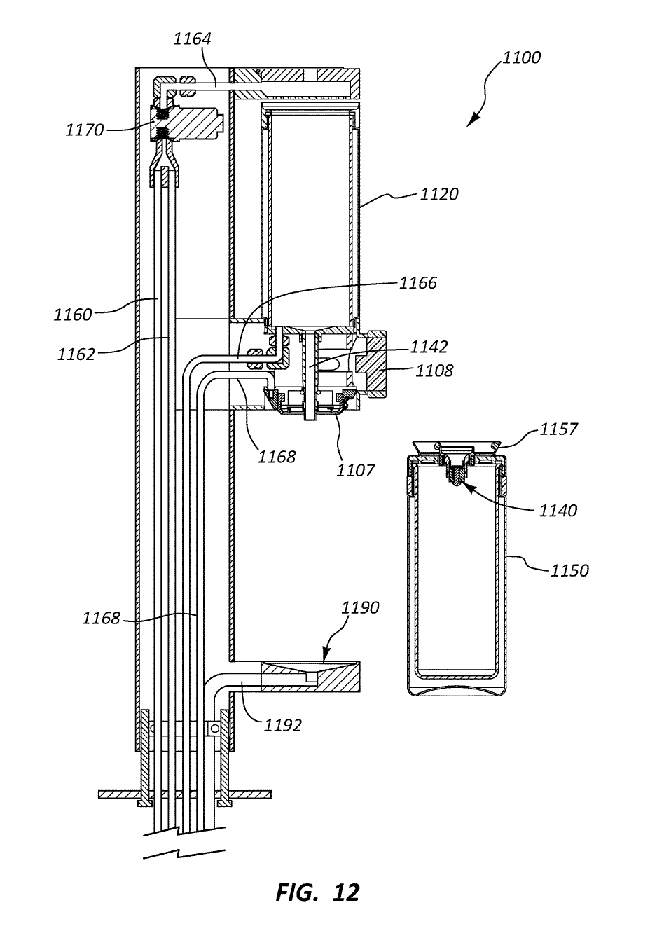

FIGS. 12-22 depict brewing assembly 1100 in various stages of a brewing process according to some implementations of preferred methods. As shown in the cross-sectional view of FIG. 12, brewing assembly 1100 comprises a plurality of fluid lines, namely, a hot water feed line 1160, a return line 1162, a dosing line 1164, a steam feed line 1166 or another feed line, such as an air/gas or water feed line, and a vacuum line 1168. Hot water feed line 1160 is preferably coupled at one end to a source for heated water, such as a boiler (not shown) and is fluidly coupled to both dosing line 1164 and return line 1162. A dosing valve 1170 is positioned in between dosing line 1164 on one side and hot water feed line 1160 and return line 1162 on the opposite side. As also discussed in greater detail below, a drain line 1192 may be provided to receive water or another liquid from a drain 1190 during a self-cleaning process.

A valve 1140 is positioned in between brewing chamber 1120 and delivery chamber 1150. In the depicted embodiment, valve 1140 is an integral part of delivery chamber 1150 and is fluidly and sealingly coupled with a fluid delivery port 1142 extending between brewing chamber 1120 and delivery chamber 1150. In the depicted embodiment, fluid-delivery port comprises a vacuum-actuated fluid delivery port 1142, for reasons that will become apparent. In alternative embodiments, valve 1140 may be positioned elsewhere, such as, for example, within frame 1105. In addition, in some embodiments, valve 1140 may replace port/tube 1142.

As previously described, valve 1140 may comprise a manual valve, a passive valve, such as a vacuum-actuated valve, or an electronic valve. In some preferred embodiments, valve 1140 comprises a spring-loaded, passive valve that may be actuated by application of a pressure differential. Thus, upon application of a vacuum through vacuum line 1168 into delivery chamber 1150, valve 1140 may be configured to open to allow for delivery of a brewed beverage from brewing chamber 1120 to delivery chamber 1150. In the depicted embodiment, vacuum line 1168 extends through frame 1105 and is fluidly and sealably coupled to delivery chamber 1150 (once delivery chamber 1150 is coupled with the rest of assembly 1100).

As described in connection with previous embodiments, valve 1140 may comprise an actively-actuated valve, such as an electronic valve, in which case a pressure differential from vacuum line 1168 may be used solely, or primarily, for drawing liquid between brewing chamber 1120 and delivery chamber 1150 rather than for opening valve 1140. Of course, in some embodiments, this pressure differential/vacuum may be used to both open valve 1140 and assist in liquid delivery.

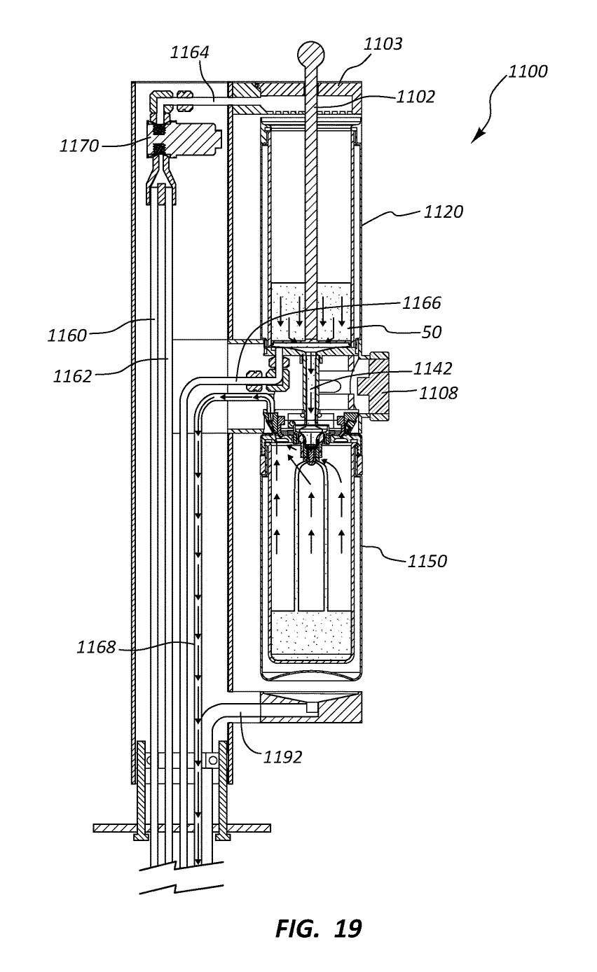

In some embodiments, port 1142 may not comprise a vacuum-actuated fluid delivery port, or may comprise serve as a vacuum-actuated port only during some stages of a brewing process. For example, as described below in connection with FIG. 19, in some embodiments, during a rinsing stage, port 1142 may allow for delivery of a rinsing liquid or other fluid therethrough, which delivery may not be actuated by operation of a vacuum. Nevertheless, because port 1142 is configured to be vacuum-actuated in earlier stages, as mentioned above, in the depicted embodiment it may still be considered a “vacuum-actuated fluid delivery port” for purposes of this disclosure.

As previously mentioned, in some embodiments, the delivery chamber/carafe 1150 may be removable from the assembly 1100. Thus, as depicted in FIG. 12, delivery chamber 1150 has been removed from frame 1105. As also shown in this figure, delivery chamber 1150 may comprise one or more protrusions 1157, or other elements that may be used to couple and/or lock delivery chamber 1150 with frame 1105. For example, in the depicted embodiment, protrusion(s) 1157 may be configured to engage respective corresponding receptacle(s) 1107 formed within a portion of frame 1105. In some embodiments, this may allow for delivery chamber 1150 to be locked in place upon rotating delivery chamber 1150 with respect to frame 1105.

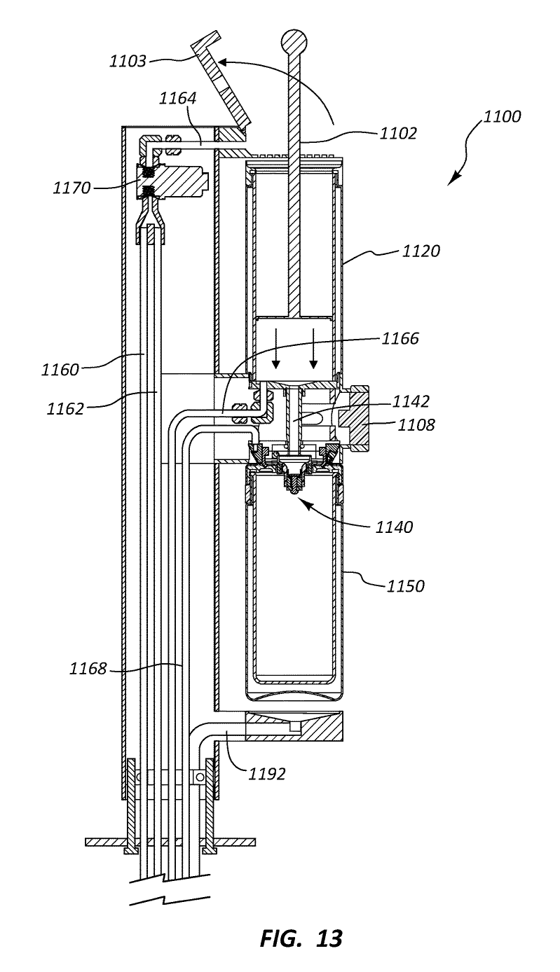

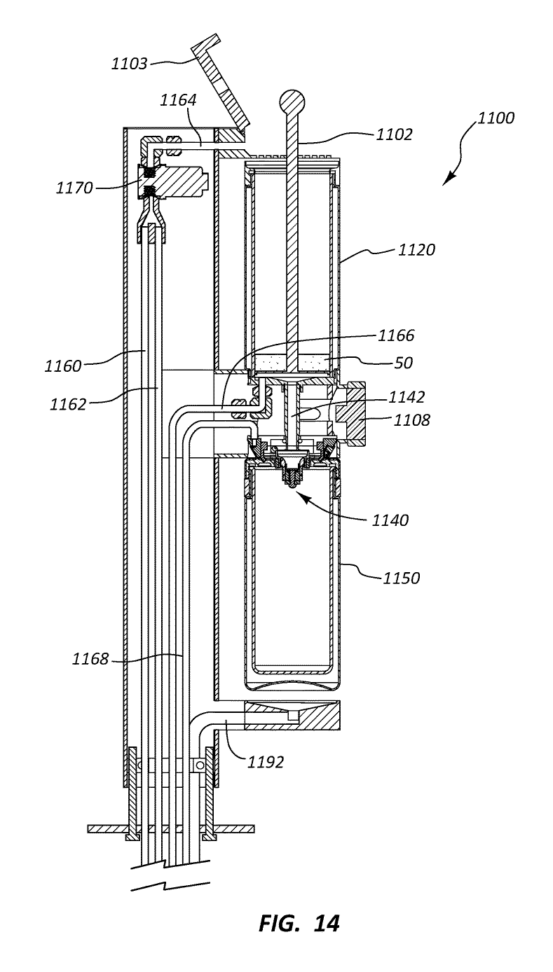

After coupling delivery chamber 1150 with frame 1105, a piston 1102 may be inserted into brewing chamber 1120, as depicted in FIG. 13. Preferably, a lid 1103 is also provided, through which an upper portion of piston 1102 may extend. A filter and brewing material 50 may then be inserted into brewing chamber 1120 on top of piston 1102, as depicted in FIG. 14, after which lid 1103 may be closed and/or locked in place.

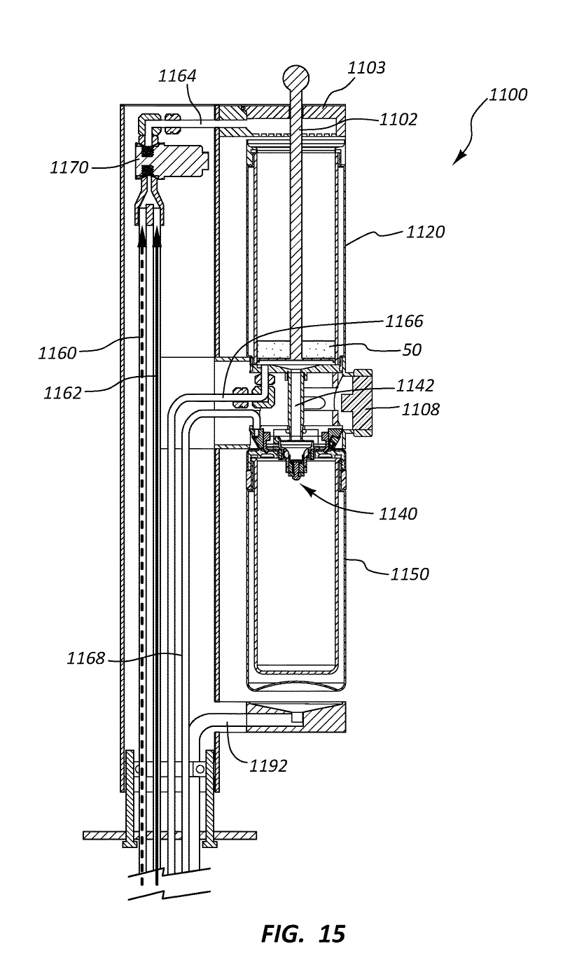

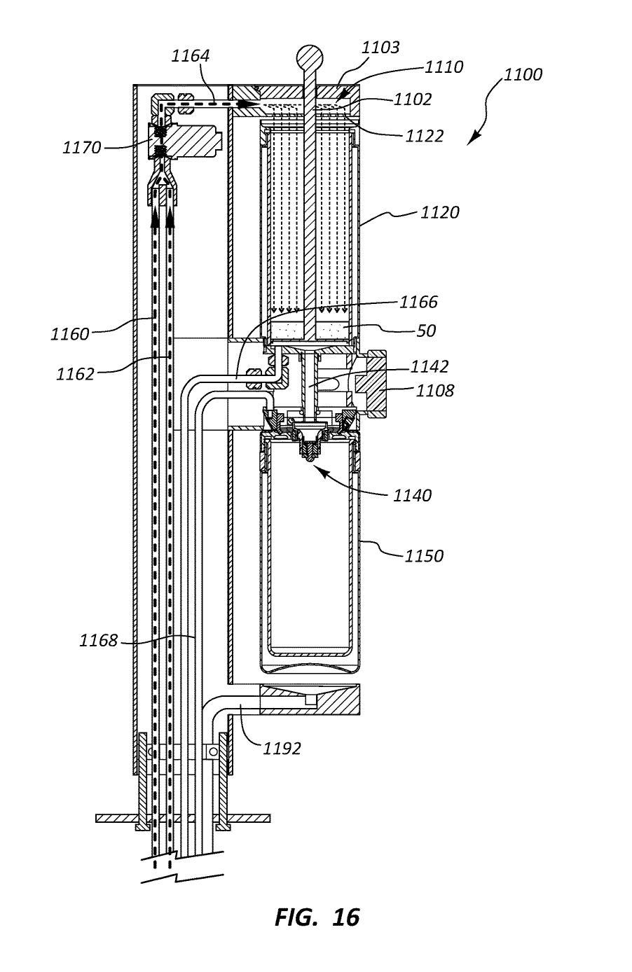

As depicted in FIGS. 15 and 16, in some embodiments and implementations, a pre-infusion stage may then be entered. In some embodiments and implementations, a user may first enter desired brewing characteristics, in some cases by recalling a saved recipe, on user interface 1108. Upon receiving instructions for the recipe, brewing assembly 1100 may be configured to deliver heated water or another liquid through feed line 1160, into dosing line 1164, and into brewing chamber 1120. More particularly, in the depicted embodiment, heated water is delivered into a liquid chamber 1110 located above brewing chamber 1120 and then may be delivered through one or more shower ports 1122 into brewing chamber 1120, as depicted in FIG. 16. It may be preferred in some embodiments to provide a plurality of evenly, or at least substantially evenly, distributed ports 1122. Moreover, some embodiments may be configured to forcefully deliver the heated water through ports 1122 to provide for pre-infusion agitation with water, steam, or another fluid (such as hot air), as discussed above.

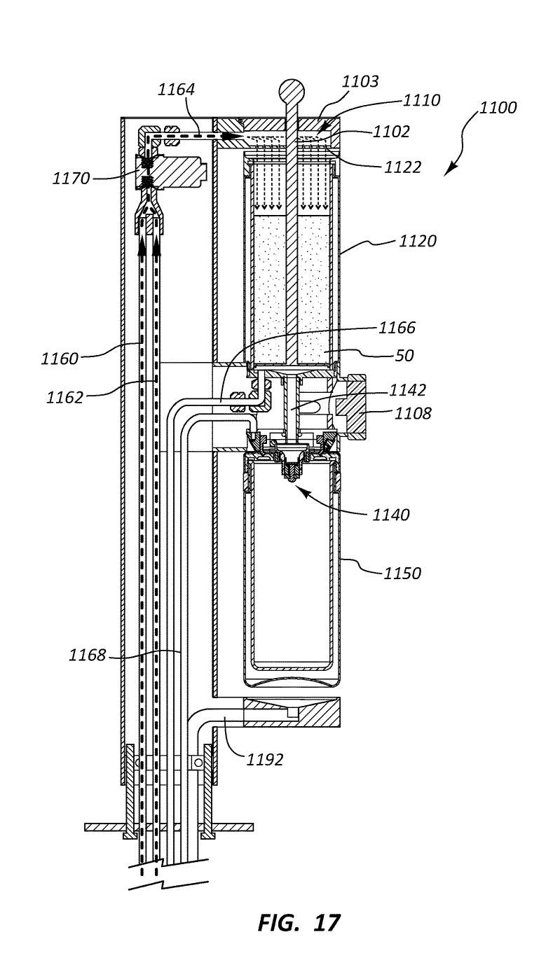

Following pre-infusion, a full immersion process may then begin. Thus, as depicted in FIG. 17, brewing material 50 may be fully immersed with heated water or another liquid. Preferably, the heated water or other fluid(s) for full immersion is delivered from the same source/line 1160 as the pre-infusion water. However, separate lines may be used if desired. Similarly, the heated water or other fluid(s) for full immersion may be delivered through the same ports, namely, shower ports 1122 or, alternatively, may be delivered through another port or ports. For example, if agitation is desired for pre-infusion but not needed during full immersion, other ports may be used, if desired, that need not deliver the heated water particularly forcefully. As also previously mentioned, in some implementations, certain steps/stages may be skipped. For example, when brewing tea, pre-infusion may not be needed or, for certain tastes for tea, coffee, or otherwise, pre-infusion may not be desired and therefore may be de-selected or otherwise not provided.

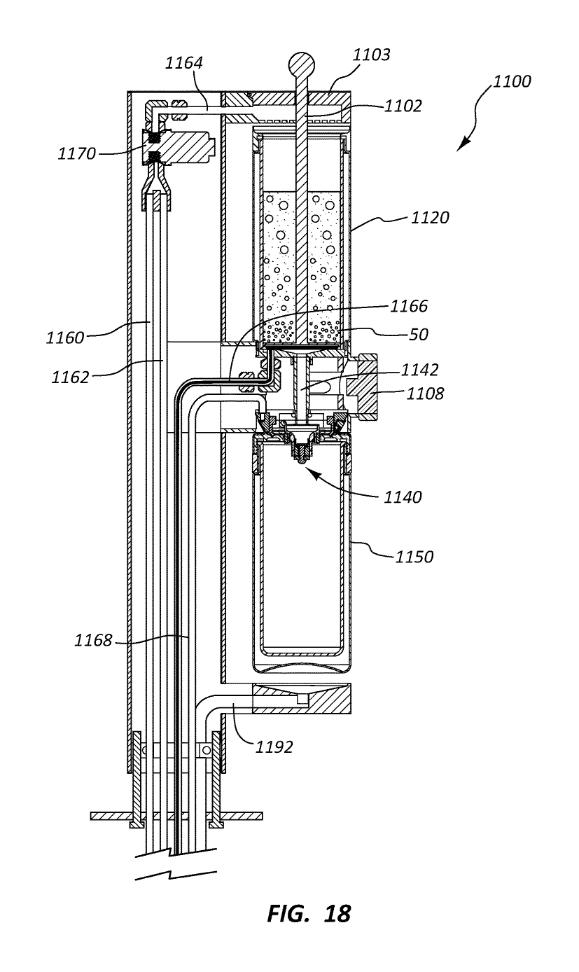

In some implementations and embodiments, one or more additional steps/stages may be provided. For example, a steam and/or heated air/gas agitation stage may be used to agitate the brewing material to obtain a unique extraction from the material and/or more evenly distribute the particles/material. FIG. 18 illustrates such a stage. As depicted in this figure, steam may be delivered into brewing chamber 1120 through steam/gas line 1166. In some implementations, steam, heated gas/air, or another suitable fluid may be delivered in multiple pulses and/or agitation stages. In some embodiments and implementations, as suggested above, the type, number, force, duration, or other parameters of the steam agitation may be selected and/or programmed by a user, and/or may be configured as part of recipes used by the assembly.

Although it is suggested by the order of FIGS. 12-22 that the steam/gas agitation stage follows full immersion, it is contemplated that alternative implementations may comprise steam agitation during pre-infusion, either in addition to or as an alternative to steam agitation following full immersion.

Following each of the various pre-infusion and other brewing steps/stages, extraction of the brewed beverage may begin, as indicated in FIG. 19. In preferred embodiments and implementations, this may begin by applying a pressure differential within delivery chamber 1150, which may be initiated by pulling air through vacuum line 1168. The pressure differential caused thereby may result in opening of valve 1140, which allows brewed beverage to be delivered from brewing chamber 1120 to delivery chamber 1150 through fluid delivery port 1142.

Alternatively, valve 1140 may be opened by other means, such as by transmission of an electrical signal. In some implementations and embodiments, a pressure differential may be introduced at the same time, or near the same time, as opening of valve 1140 to assist in liquid transfer/extraction.

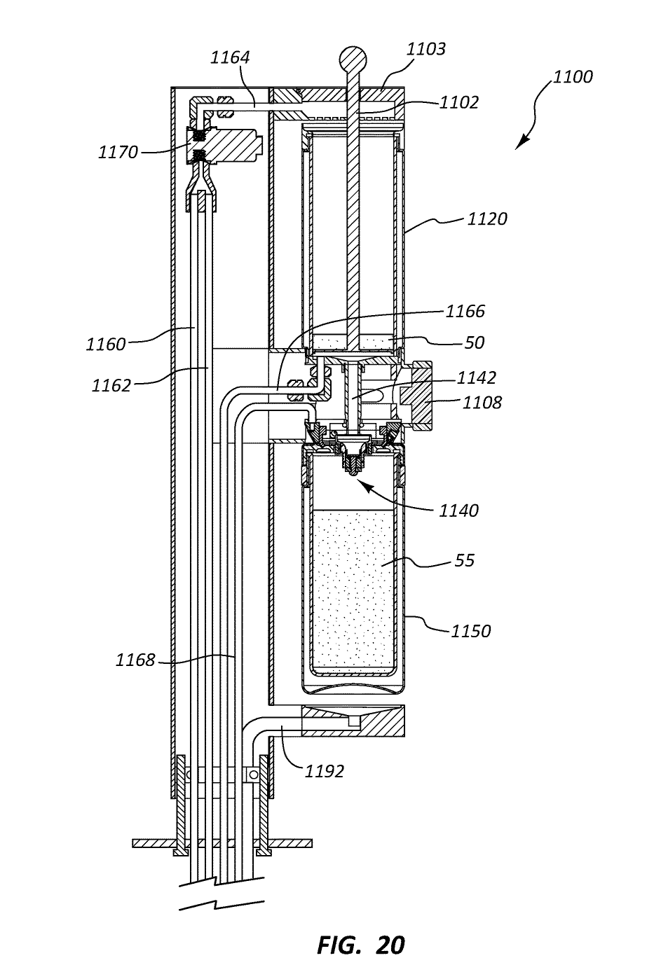

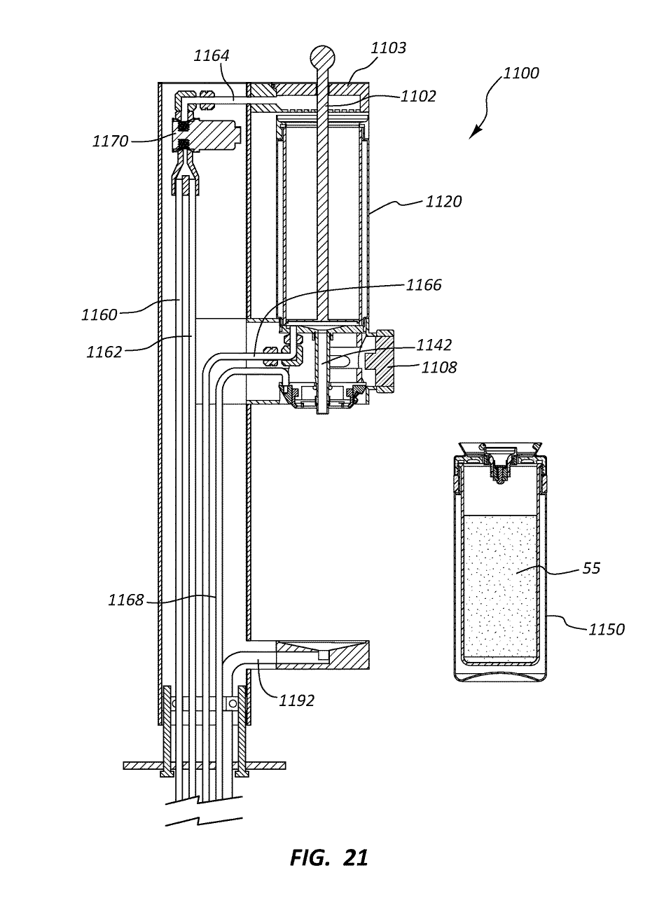

Once extraction has been completed, the coffee grounds or other brewing material 50 will remain in brewing chamber 1120, and the finished beverage 55 will be in the delivery chamber/carafe 1150 below, as illustrated in FIG. 20. The delivery chamber/carafe 1150 may then be removed from the assembly 1100, as shown in FIG. 21. The delivery chamber/carafe 1150 may, for example, be removed from the assembly 1100 by rotating and/or unscrewing delivery chamber 1150, by actuation of a release mechanism, or, in some embodiments, simply by pulling the delivery chamber/carafe 1150 away from the assembly 1100.

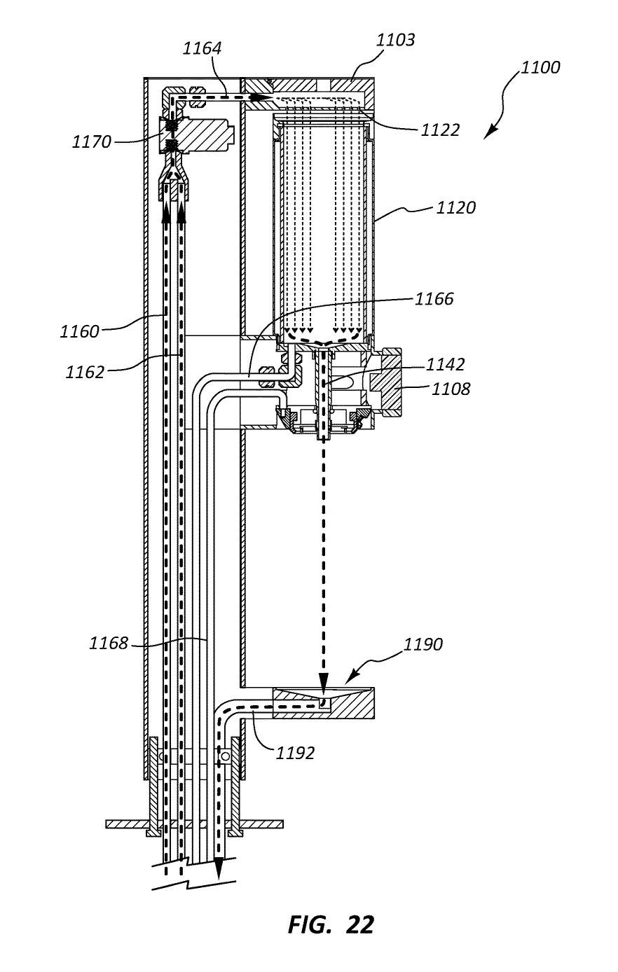

Some embodiments may further be configured to provide for a cleaning and/or rinsing stage. Thus, as shown in FIG. 22, rinsing water, which in some embodiments/implementations may be the same heated water delivered through line 1160 that is used to deliver water for brewing, may be delivered through brewing chamber 1120. In some such embodiments and implementations, one or more of the agitation steps/stages/components, such as shower ports 1122 and/or steam/gas line 1166, may be used to aid in cleaning/rinsing. Following sufficient rinsing/cleaning, the water or other fluid used to clean/rinse may be delivered through port 1142, after which it may be collected in drain 1190 and disposed of through drain line 1192.

Although the depicted embodiment is configured to allow for rinsing water to freely flow through port 1142, in alternative embodiments, a separate valve (not shown) may be used to allow for selective opening of port 1142 following sufficient rinsing/cleaning.

In alternative embodiments, drain and/or drain line 1192 may be fluidly coupled with fluid delivery port 1142. In some such embodiments, valve 1140 may comprise a three-way valve, which may be moved into another location within the assembly rather than in delivery chamber 1150. For example, a three-way valve may be positioned along fluid delivery port 1142 and may be used to operate in three configurations: a first open configuration in which brewing chamber 1120 is fluidly coupled with delivery chamber 1150; a second open configuration in which brewing chamber 1120 is fluidly coupled with drain line 1192 and/or drain 1190; and a closed configuration in which brewing chamber 1120 is fluidly closed with respect to both delivery chamber 1150 and drain line 1192. This configuration may allow for use of drain line 1192 as a “wash” line, either as an alternative to or in addition to as a drain line. In other words, use of a three-way valve may allow for directing fluids to line 1192 during various wash cycles, which may be particularly useful in connection with tea brewing, as previously discussed. Such fluids may alternatively be directed to delivery chamber 1150 for consumption, if desired, which may be facilitated by providing a three-way valve.

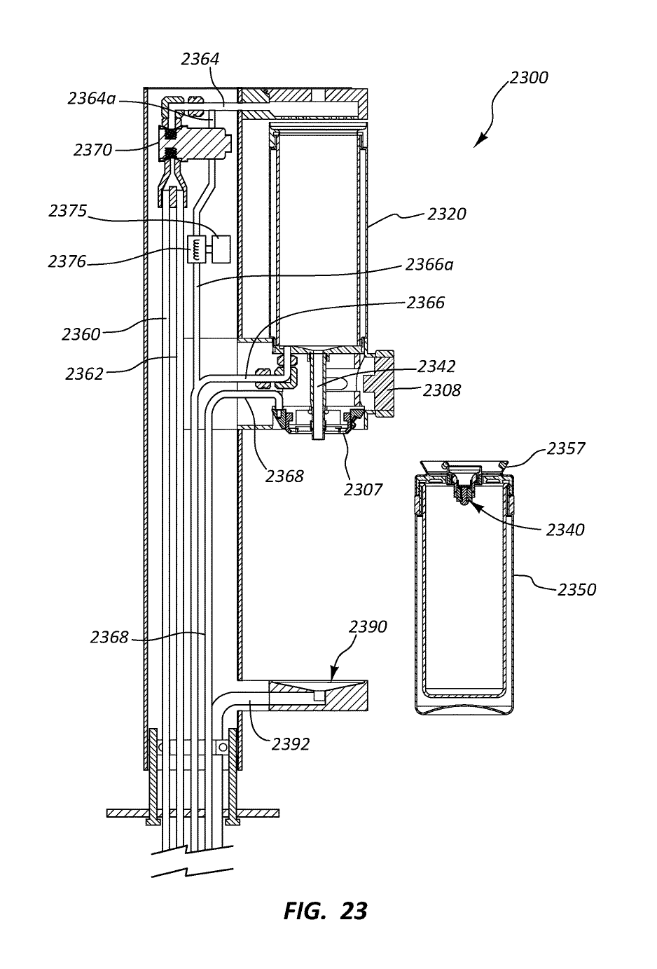

FIG. 23 illustrates yet another embodiment of a brewing assembly 2300. Brewing assembly 2300 is similar to brewing assembly 1100 with a few exceptions explained below. Brewing assembly 2300 is depicted in cross-section to illustrate these differences, but otherwise may be generally similar to brewing assembly 1100 and may comprise one or more of the elements/components of brewing assembly 1100 that may not be visible in the cross-sectional view of FIG. 23. Brewing assembly 2300, like brewing assembly 1100, may be more suitable for use as a commercial brewer. However, those of ordinary skill in the art will appreciate that, with certain modifications, brewing assembly 2300 may be reconfigured for use as a home brewer.

Brewing assembly 2300 comprises a brewing chamber 2320 positioned at the upper end of the assembly and a delivery chamber 2350 positioned below brewing chamber 2320. Delivery chamber 2350 is fluidly coupled with brewing chamber 2320. Preferably, delivery chamber 2350 is also fluidly sealed, or at least substantially fluidly sealed, with respect to brewing chamber 2320. For example, as previously mentioned, and as described below in more detail, one or more valves may be provided in between brewing chamber 2320 and delivery chamber 2350 that may allow for delivery of fluid between these two chambers. For example, as previously discussed, upon actuation of a vacuum-controlled valve by selective application of a pressure differential within delivery chamber 2350, brewed beverage may be delivered into delivery chamber 2350. Thus, with respect to the depicted embodiment, delivery chamber 2350 may also be considered a vacuum chamber.

In some embodiments, one or more features/components may be used to allow for selective release and/or locking of delivery chamber 2350 in place. In this manner, delivery chamber 2350 may be removed from brewing assembly 2300 and used to pour coffee or another brewed beverage into other containers. In some embodiments, delivery chamber 2350 may be removed and used as a single-serve container. In some such embodiments, delivery chamber 2350 may be disposable or at least replaceable with another similar delivery chamber 2350. Thus, for example, in some embodiments, delivery chamber 2350 may be used to receive the brewed beverage and then may be delivered to a customer and/or consumer in the same container for consumption and then replaced with a new delivery chamber or other similar container for subsequent brewing.

As also shown in the cross-sectional view of FIG. 23, brewing assembly 2300 comprises a plurality of fluid lines, namely, a hot water feed line 2360, a return line 2362, a dosing line 2364, a steam feed line 2366, and a vacuum line 2368. Hot water feed line 2360 is preferably coupled at one end to a source for heated water, such as a boiler (not shown) and is fluidly coupled to both dosing line 2364 and return line 2362.

In addition, unlike brewing assembly 1100, brewing assembly 2300 comprises a heated gas system that may be used to alter the temperature of one or more components of the assembly before a brewing process and/or maintain a desired temperature for the assembly 2300, or one or more specific elements/components of assembly 2300, in between brews. For example, in some preferred embodiments and implementations, assembly 2300 may comprise a heated air/gas system that may be used to warm one or more of the chambers of assembly 2300 just prior to brewing. This pre-heating may be used to keep beverages more consistent from brew to brew irrespective of whether the machine has been sitting for a while between brews or is continually brewing.

In the depicted embodiment, this pre-heating and/or gas system comprises an air-pump 2375 and a heating element 2376, such as a heating coil, such that heated air can be fed through a line fluidly coupled with brewing chamber 2320. In some embodiments, the heated air or other gas may lack steam. In other words, although in the case of air there may be some water in the air, as would typically be the case for breathable air, the gas/air may lack an input of additional heated water and may therefore be considered to “lack steam” for purposes of this disclosure. In the depicted embodiment, this gas fluid line 2364a is directly coupled with another line that, in turn, is coupled with brewing chamber 2320. More particularly, gas fluid line 2364a is coupled between heating coil 2376 and/or air pump 2375 and dosing line 2364. Thus, dosing line 2364 may be used to deliver both liquid and gas. However, those of ordinary skill in the art after having received the benefit of this disclosure will appreciate that a separate dedicated gas line may be used to deliver gas into brewing chamber 2320 and/or delivery chamber 2350 if desired. In some preferred implementations of brewing methods using brewing assembly 2300, a vacuum pump may be actuated simultaneously, or at least substantially simultaneously, to force hot air circulation through both chambers 2320 and 2350 so as to pre-heat both brewing chamber 2320 and delivery chamber 2350 prior to brewing.

In some embodiments and implementations, a single pump may be used for both agitation of the brew during brewing and for maintaining temperature before or during the brew process. Thus, for example, brewing assembly 2300 comprises a second line 2366a fluidly coupled in between line 2366 and one or both of heating element 2376 and air pump 2375. Thus, a valve may be used to direct heated air or another gas through either line 2364a or line 2366a depending upon whether heated gas agitation is desired or whether pre-brewing temperature maintenance is desired. In some embodiments and implementations, the temperature maintenance system may also tie in with a steam delivery line to assist in delivery of the steam and/or to provide for a dryer and/or hotter steam than would be possible without a heated air/gas line. However, in alternative embodiments and implementations, brewing assembly 2300 may be configured so as to entirely replace steam delivery with a single pump/fan-heating element assembly for delivery of hot air for preheating through the water delivery area as well as agitation during brewing, if desired.

A dosing valve 2370 is positioned in between dosing line 2364 on one side and hot water feed line 2360 and return line 2362 on the opposite side. Also, as discussed in connection with assembly 2300, a drain line 2392 may be provided to receive water or another liquid from a drain 2390 during a self-cleaning process.

As with assembly 1100, assembly 2300 may comprise a valve 2340 positioned in between brewing chamber 2320 and delivery chamber 2350. In the depicted embodiment, valve 2340 is an integral part of delivery chamber 2350 and may be used to fluidly and sealingly couple with a fluid delivery port 2342 extending between brewing chamber 2320 and delivery chamber 2350. In the depicted embodiment, fluid-delivery port 2342 comprises a vacuum-actuated fluid delivery port, as previously discussed.

As also previously described, valve 2340 may comprise a manual valve, a passive valve, such as a vacuum-actuated valve, or an electronic valve. In some preferred embodiments, valve 2340 comprises a spring-loaded, passive valve that may be actuated by application of a pressure differential. Thus, upon application of a vacuum through vacuum line 2368 into delivery chamber 2350, valve 2340 may be configured to open to allow for delivery of a brewed beverage from brewing chamber 2320 to delivery chamber 2350.

As also described in connection with previous embodiments, valve 2340 may comprise an actively-actuated valve, such as an electronic valve, in which case a pressure differential from vacuum line 2368 may be used solely, or primarily, for drawing liquid between brewing chamber 2320 and delivery chamber 2350 rather than for opening valve 2340. Of course, in some embodiments, this pressure differential/vacuum may be used to both open valve 2340 and assist in liquid delivery.

As previously mentioned, in some embodiments, the delivery chamber/carafe 2350 may be removable from the assembly 2300, as depicted in FIG. 23. As also shown in this figure, delivery chamber 2350 may comprise one or more protrusions 2357, or other coupling and/or locking elements that may be used to couple and/or lock delivery chamber 2350 with another element of assembly 2300, such as within a respective corresponding receptacle(s) 2307 formed within a portion of a frame of assembly 2300.

Although not shown in FIG. 23, as previously discussed in connection with other embodiments, after coupling delivery chamber 2350 with the frame, a piston may be inserted into brewing chamber 2320 to further facilitate the brewing process. Other aspects of assembly 2300 may also be similar to previously-described embodiments. For example, brewing assembly 2300 may further comprise a control display/user interface 2308 that may be used to allow a user to operate the device. In some embodiments, as previously explained, user interface 2308 may be used to allow a user to program specific recipes, which may incorporate one or more of the parameters discussed above, to allow a user to dial in a most preferred set of parameters for a particular beverage, save the “recipe” associated with such parameters, and be able to easily repeat it without requiring re-entry of each parameter manually.

As another example of a feature not specifically shown in FIG. 23 but contemplated as an alternative embodiment, valve 2340 may be incorporated into the primary housing/body of assembly 2300 if desired. In some such embodiments, valve 2340 may comprise a three-way valve that may be coupled with a rinse/drain/wash line, as previously mentioned, to allow for automated cleaning, rinsing, and/or washing during a brew process, one or more of which may be controlled by a used as part of a set of brew parameters, as previously mentioned.

It will be understood by those having skill in the art that changes may be made to the details of the above-described embodiments without departing from the underlying principles presented herein. Any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein. The scope of the present inventions should, therefore, be determined only by the following claims.

1. A brewing assembly for brewing a beverage, comprising:
a brewing chamber configured to brew a beverage therein;
a delivery chamber configured to receive a brewed beverage from the brewing chamber;
a valve positioned between the brewing chamber and the delivery chamber,
wherein the delivery chamber is fluidly sealed with respect to the brewing chamber, and
wherein the valve is configured to, upon actuation, allow for fluid communication between the brewing chamber and the delivery chamber; and
a vacuum tube coupled with the delivery chamber and configured to apply a pressure differential to assist in delivering the brewed beverage from the brewing chamber to the delivery chamber.

2. The brewing assembly of claim 1, wherein the valve comprises a passive valve.

3. The brewing assembly of claim 2, wherein the valve comprises a vacuum-actuated valve.

4. The brewing assembly of claim 3, wherein the vacuum-actuated valve is configured to automatically open to allow for delivery of the brewed beverage from the brewing chamber to the delivery chamber upon generation of a predetermined pressure differential between the delivery chamber and the brewing chamber.

5. The brewing assembly of claim 1, wherein the delivery chamber comprises a carafe, and wherein the carafe is removable from the brewing assembly.

6. The brewing assembly of claim 1, wherein the valve comprises a three-way valve.

7. The brewing assembly of claim 6, further comprising a drain line coupled with the three-way valve, wherein the three-way valve is configured to operate in three configurations comprising:
a first configuration in which the three-way valve allows for fluid communication between the brewing chamber and the delivery chamber;
a second configuration in which the three-way valve allows for fluid communication between the brewing chamber and the drain line; and
a third configuration in which the three-way valve prevents liquid from the brewing chamber from entering either the delivery chamber or the drain line.

8. A brewing assembly for brewing a beverage, comprising:
a brewing chamber configured to brew a beverage therein;
a delivery chamber configured to receive a brewed beverage from the brewing chamber;
a gas line for delivery of a temperature-controlled gas into at least one of the brewing chamber and the delivery chamber;
a valve positioned between the brewing chamber and the delivery chamber; and
a heating element functionally coupled with the gas line and configured to heat a gas prior to delivery of the gas into the brewing chamber.

9. The brewing assembly of claim 8, wherein the brewing assembly is configured to deliver the temperature-controlled gas into the at least one of the brewing chamber and the delivery chamber prior to the brewing chamber receiving a liquid therein for brewing the beverage.

10. The brewing assembly of claim 8, wherein the gas lacks steam.

11. The brewing assembly of claim 10, wherein the gas comprises air.

12. The brewing assembly of claim 10, further comprising a steam feed line configured to deliver steam into the brewing chamber during brewing.

13. The brewing assembly of claim 12, wherein the gas line is fluidly coupled with the steam feed line.

14. The brewing assembly of claim 8, further comprising a vacuum pump configured to generate a pressure differential between the brewing chamber and the delivery chamber.

15. The brewing assembly of claim 14, wherein the valve comprises a vacuum-actuated valve configured to open upon actuation of the vacuum pump to allow the brewed beverage to flow from the brewing chamber to the delivery chamber.

16. A method for brewing a beverage, the method comprising the steps of:
delivering a liquid into a brewing chamber;
initiating a brew process in the brewing chamber;
applying a pressure differential between the brewing chamber and a delivery chamber;
opening a valve between the brewing chamber and the delivery chamber; and
delivering a brewed beverage from the brewing chamber into the delivery chamber.

17. The method of claim 16, wherein the valve comprises a passive valve, and wherein the step of opening the valve is performed automatically upon applying the pressure differential between the brewing chamber and the delivery chamber.

18. The method of claim 16, wherein the valve comprises an electronically-actuatable valve, and wherein the step of opening the valve comprises delivering a signal to the valve to open the valve.

19. The method of claim 16, wherein the step of applying a pressure differential between the brewing chamber and the delivery chamber comprises actuating a vacuum pump fluidly coupled with the delivery chamber.

20. The method of claim 16, further comprising selecting a recipe comprising a plurality of brew parameters on a user interface, wherein the plurality of brew parameters comprises at least a desired temperature for the liquid used for brewing, and wherein the step of initiating the brew process in the brewing chamber comprises automatically brewing a beverage according to each of the plurality of brew parameters.

21. The method of claim 20, wherein the brew process comprises full immersion brewing.

22. The method of claim 21, wherein the brew process further comprises at least one pre-infusion stage comprising at least one of a pre-wetting stage of brewing material and an agitation stage of brewing material prior to the full immersion brewing.
